(19) United States
(12) Patent Application Publication
(10) Pub. No.: US 2008/0243539 A1
(43) Pub. Date: Oct. 2, 2008

(54) Method and System for Exchanging, Storing, and Analyzing Health Information

(76) Inventors: Matthew A. Barish, Boston, MA (US); Robert C. Smith, Rockville, MD (US); Grant Chieh-Hsiang Yang, Sunnyvale, CA (US)

Correspondence Address: ROBERT C. SMITH, 14204 ARBOR FOREST DRIVE, ROCKVILLE, MD, 20850, US

(21) Appl. No.: 11/694,953

(22) Filed: Mar. 31, 2007

(51) Int. Cl. G06Q 50/00

(52) U.S. Cl. 705/2

(57) ABSTRACT

A method and system for storing health information, automatically matching health information to interpreters based on parameters provided by the interpreters and the health information providers, and transmitting interpretations of the health information provided by the interpreters. Interpreters may be rated according to their analysis quality and dependability on providing interpretations.

### BACKGROUND

The number of interpretations of health information performed in the United States has steadily increased over time. For example, interpretations of imaging tests currently exceed half a billion tests per year. While the number of imaging tests has rapidly grown and the types of imaging tests have shifted to cross-sectional studies, the number of interpreters, such as radiologists, available to interpret these images has not increased at nearly the same pace.

Health information providers, such as imaging test producers and providers, frequently contract with large numbers of independent interpreters, such as radiologists or large multi-specialty radiology groups, to interpret health information, such as imaging tests. Due to a shortage of radiologists in many locations, imaging test producers typically pay individual radiologists, radiology groups or “locum tenens” radiologists to interpret general or sub-specialty radiology tests or to cover for vacations and other absences. Many imaging test producers (including small hospitals) spend considerable time, money and effort recruiting, licensing, and credentialing physicians to interpret imaging tests for their site. In order to attract a sufficient number of qualified radiologists to interpret tests at peak times and to cover vacations and holidays, imaging test producers often must contract with a larger number of radiologists than is truly necessary. At peak demand, radiologists are overworked and turn-around-times are prolonged. During off-peak times, radiologists have insufficient volume to generate sufficient revenue to support salaries. In addition, expertise to read advanced sub-specialty studies may be extremely limited in certain areas and may be limited in all areas at certain times.

Many imaging test producers have difficulties in efficiently interpreting studies while employing or contracting with a sufficient number of radiologists to cover all sub-specialties. In order to have expert opinions, imaging test producers such as hospital-based radiology departments and private practice radiology groups must employ a sufficient number of specialists. These specialists will be under utilized if they read studies only within their own specialty. At the same time, when specialists read outside their specialty, they defeat the purpose of having specialists. Case volume depends on the time of day and patient flow patterns. In order to maintain satisfactory turn-around times, imaging test producers must be overstaffed during lulls or understaffed during peak times. Coverage for weekends, vacations and holidays requires a level of staffing which guarantees an overabundance of radiologists during certain times of the year. Coverage needs outside of regular working hours (i.e., coverage needs between 5 pm and 8 am the following morning) further exacerbates these problems. This has lead to a rise in so-called “Nighthawk,” or “after-hours,” teleradiology services. These after-hours services may provide a final or preliminary interpretation of an imaging test, with the latter the most common model of after-hours services. A problem for many imaging test producers that do not also interpret all of their own tests is that they are tied to an individual radiology group and the group may experience episodes of short staffing or recruitment difficulties which negatively impact quality of service and timeliness. It is difficult for any individual imaging test producer to assess the quality of the interpretations (particularly for interpretation services provided under contract.)

In the current inefficient system, there is an overall shortage of radiologists to perform all of the needed interpretive services. As imaging tests continue to increase, this problem will worsen. Regional hospital chains and regional imaging center chains will be looking for groups that can read for all their hospitals or centers and provide quality, sub-specialization, consistency, and a single contract.

On the other side, radiologists are dependant on the steady production of imaging tests by imaging test producers in order to remain efficient and revenue productive. This means that an individual radiologist would have to contract with multiple imaging test producers in order to receive sufficient work to generate enough revenue to maintain sufficient salary. Unfortunately, the production of imaging tests is not balanced to the availability of radiologists in any given locale or at any given time.

### BRIEF DESCRIPTION OF THE DRAWINGS

FIG. 1a illustrates a diagram of an example configuration of an example health information exchange system, according to an example embodiment of the present invention.

FIG. 1b illustrates another example configuration of an example health information exchange system, according to an example embodiment of the present invention.

FIG. 2 illustrates an example data structure of data stored in connection with a health information exchange system, according to an example embodiment of the present invention.

FIG. 3a illustrates a flowchart of an example system of registering users and health information providers to a health information exchange system and matching health information to interpreters, according to an example embodiment of the present invention.

FIG. 3b illustrates a flowchart of an example process of acquiring an account, according to the example embodiment of FIG. 3a.

FIG. 3c illustrates a flowchart of an example process of receiving and adjusting of preferences, according to the example embodiment of FIG. 3a.

FIG. 3d illustrates a flowchart of an example process to receive health information, according to the example embodiment of FIG. 3a.

FIG. 3e illustrates a flowchart of an example process of administering matches between health information and interpreters, according to the example embodiment of FIG. 3a.

FIG. 3f illustrates a flowchart of an example process of performing second reads, according to the example embodiment of FIG. 3a.

FIG. 3g illustrates a flowchart of an example process of notifying an on-call interpreter, according to the example embodiment of FIG. 3a.

FIG. 3h illustrates a flowchart of an example process of the charging calculation for determining the bill for a health information, according to the example embodiment of FIG. 3a.

FIG. 3i illustrates a flowchart of an example process of attributing ratings based on an interpretation of a health information, according to the example embodiment of FIG. 3a.

FIG. 4a illustrates a flowchart of an example process of providing journal articles and advertisements to participants in a health information exchange system, according to an example embodiment of the present invention.

FIG. 4b illustrates a flowchart of an example process of receiving surveys and blind reads from interpreters in a health information exchange system, according to an example embodiment of the present invention.

FIG. 5a illustrates an example health information template interface that may be viewed by a health information provider, according to an example embodiment of the present invention.

FIG. 5b illustrates an example interface of a data sheet of health information that may be viewed by a health information provider, according to an example embodiment of FIG. 5a.

FIG. 5c illustrates an example interface of a health information template, according to an example embodiment of the present invention.

FIG. 5d illustrates part of an example interface of a display for a health information exchange system, according to an example embodiment of the present invention.

FIG. 5e illustrates an example interface of a worklist display, according to an example embodiment of FIG. 5d.

### DETAILED DESCRIPTION

Example embodiments of the present invention include systems and methods for receiving, storing, and matching health information, such as image data, medical images or other image information from imaging tests, to medical personnel, such as radiologists, to interpret the imaging tests. Example embodiments may include a health information matching system, which may include the components to provide the matching of health information to interpreters and populating a worklist. Example embodiments may also include a health information exchange system, which may provide additional storage, retrieval, and manipulation health information or data relating to health information. A health information matching system may be contained within a health information exchange system, retrieving health information data to match from the health information exchange system. The health information matching system may also be an intermediary between health information providers and interpreters, and receiving and directing matches and data to the necessary recipients. Or, the health information matching system may be integrated with the health information exchange system and matching, storing, retrieving, and manipulating health information directly from storage or other sources of the health information exchange system.

Diagnostic tests are a common type of health information that requires interpretation. Imaging tests are a subgroup of diagnostic tests. Imaging tests include conventional x-rays (e.g., chest x-ray or bone x-ray) and cross-sectional imaging studies such as computerized tomography (CT), ultrasound (US) and magnetic resonance imaging (MRI) and nuclear medicine exams (e.g., positron emission tomography (PET) scans, bone scans, etc.) While conventional x-ray tests typically comprise a few images, cross-sectional imaging tests now frequently comprise hundreds and sometimes thousands of individual images.

Imaging tests comprise image data, medical images derived from the image data as well as other imaging information. Imaging tests include conventional x-rays (e.g., chest x-ray or bone x-ray) and cross-sectional imaging studies such as computerized tomography (CT), ultrasound (US) and magnetic resonance imaging (MRI) and nuclear medicine exams (e.g., positron emission tomography (PET) scans, bone scans, etc.) While conventional x-ray tests typically comprise a few images, cross-sectional imaging tests may comprise hundreds and sometimes thousands of individual images. The imaging test and each of its component parts may be forms of health information and these may be used individually or in combination in order to interpret the imaging test. An imaging test (or one or more of its component parts, such as image data, medical images or other imaging information) may be provided to an interpreter directly by a health information provider, through the imaging test processor or some other entity that has legally obtained the imaging test (or one or more of its component parts), by other entities, or directed through the health information matching system or health information exchange system. Other entities may include patients, lawyers, pharmaceutical companies, professional organizations, etc.

Health information interpreters may include physicians or other qualified persons who interpret health information provided by health information providers. Health information providers may include a variety of entities including patients, individual physicians, physician groups, testing facilities that produce or perform diagnostic tests (e.g., imaging centers that are free-standing or affiliated with a hospital or other health care provider), entities that produce or perform imaging tests (i.e., imaging test producers), hospitals, managed care organizations, insurers, lawyers, pharmaceutical companies, etc. Entities that interpret health information, such as imaging tests or components of imaging tests, may include health information providers, image data producers, image data processors as well as individual radiologists or other physicians that are employees of, under contract with or affiliated with health information providers, such as image test producers and image test processors.

Health information may be any information, whether oral or recorded in any form or medium, that is created or received by a health care provider, health plan, public health authority, employer, life insurer, school or university, lawyer, or health care clearinghouse. Health information may relate to the past, present, or future physical or mental health or condition of an individual; the provision of health care to an individual; or the past, present, or future payment for the provision of health care to an individual. Health information may be interpreted by physicians, or other qualified persons, for purposes of diagnosis or screening for disease or other maladies.

The image data as well as the associated medical images and other imaging information may be used to interpret the imaging test. Image data, as well as the associated medical images and other imaging information derived from the image data, may be forms of health information. Health information not derived from image data (e.g., signs, symptoms, prior surgery, prior imaging tests, etc.) may also be used in conjunction with image data to interpret the imaging test. Other clinical information alone, or in conjunction with imaging data, may also aid in forming a diagnosis. Image data may also include x-ray attenuation values on CT, exposure of x-ray film or digital detectors for conventional x-ray studies, magnetic resonance signal on MRI, amplitude of reflected sound waves on ultrasound, photon counts on nuclear medicine, etc. Medical images may be two-dimensional, three-dimensional, virtual displays, etc. Other image information may comprise, for example, Doppler waveforms or flow velocity on ultrasound, contrast enhancement curves on MRI or CT, perfusion or diffusion data on MRI, etc.

Entities that produce image data may process the data, produce medical images, or create other imaging information. Image data produced by a single entity may be processed by a separate entity (image data processors) to form medical images or other image information. Entities that produce and or process image data may include hospital in-patient imaging facilities, hospital outpatient imaging facilities, outpatient imaging facilities operated by radiology groups, clinical centers, pathology labs, outpatient imaging facilities operated by corporations that contract with radiology groups or individual radiologists, non-radiologist physicians, physician offices, etc.

The method and system of an example embodiment may match health information interpreters, such as radiologists available to interpret imaging tests, to health information, such as imaging tests or components of imaging tests, requiring interpretation. The method and system of an example embodiment may provide an integrated interactive network that gives health information providers, such as imaging test providers, access to essentially every health information interpreter and that gives every health information interpreter available to interpret health information access to essentially every health information provider. In addition, the example embodiment may allow better matching of interpreters with subspecialty expertise to interpret subspecialty health information and may provide quality assessment and quality assurance.

An example embodiment may be applicable to many forms of health information including diagnostic tests that are obtained in or can be converted to a digital format such as electrocardiograms, pathology slides, pictures or movies of organ systems (e.g., the gastrointestinal tract as visualized on endoscopy), pictures or movies of disease processes such as skin abnormalities, etc. Diagnostic tests may include, for example, an imaging test, a pathology test, or any other test, such as an EKG, that may be used for medical diagnosis or screening.

An example embodiment of the present invention may be include a method for matching, that may include receiving one or more health information from a health information provider; associating a send parameter to the one or more health information, wherein a send parameter is provided by the health information provider; storing the send parameter and the one or more health information; receiving a read parameter from a radiologist; matching one or more health information to the radiologist, wherein the matching may be as a function of at least one of the send parameter, read parameter, and a time variable; providing a first health information to the radiologist; and receiving an interpretation corresponding to a health information from the radiologist.

An example embodiment may include a method for matching health information involving receiving a health information from a health information provider; associating a send parameter to the health information; storing the send parameter and the health information; receiving a read parameter from an interpreter; providing a first health information to a first interpreter; and receiving an interpretation corresponding to a health information from the interpreter. The method may further include contacting an on-call interpreter, querying the health information provider for additional health information that is associated with the first health information, querying a second health information provider for additional health information associated with the first health information, removing personally identifiable health information associated with the health information, displaying health information and a parameter, wherein the displayed parameter comprises at least one of a modality, body part, study description, time urgency, total number of images, bonus points, equipment rating, clinical data rating, and an indicia, displaying health information and an associated parameter, wherein the health information is displayed as a time function, wherein the time function is dependent on time variables comprising one of at least the time the health information was sent by the health information provider, the time the health information was received by the health information exchange system, the time by which an interpretation must be provided. The providing of the health information to the interpreter may be performed upon the matching of a read parameter and a send parameter.

An example method of matching may include altering a displayed indicia according to the time function, wherein the time function may be pre-determined by the health information provider or wherein the time function may be pre-determined by a health information matching system. The time function may be variable and depends from a system variable. The system variable may be at least one of the time function itself, the number of interpreters currently logged in to the health information matching system, the number of health information awaiting interpretation in the health information matching system, the average amount of time the plurality of health information has been in the health care information matching system, and the number of health care information not provided to any interpreters currently in the health care information matching system.

In example embodiments, the interpreter may be a doctor, such as a radiologist. A method of an example embodiment may include rating the interpreter as a function of the quality of interpretations or rating an interpreter as a function of dependability of completing interpretations. The rating may be provided by a second interpreter, a health information matching system, or the health information provider. An interpreter may be a specialist. The method of an example embodiment may further comprise verifying that the fellowship training of a specialist in a subspecialty area, verifying the academic department (e.g. a teaching hospital) in a subspecialty area, qualifying the interpreter as a specialist after a fixed number of health information interpretations are reviewed by a specialist in a subspecialty area.

In an example embodiment, interpreters may be provided a bonus. An example embodiment may include associating a bonus score to an interpreter. A bonus score may be a function of at least one of a rating associated with the interpreter; the number of interpretations provided by the interpreter; the number of interpretations received by the interpreter; a comparison of an interpreter's rate of interpreting compared to other interpreters on a health information matching system; registering as a specialist; availability at designated times of the day; participation in an on-call system; and a quality rating of the interpreter.

An example embodiment may have send parameters, wherein the send parameter may be provided by the health information provider or a health care information matching system. A send parameter may be one of a time frame, a range of price, a location a minimum price as a function of other send parameters, radiology specialty, a specific group of doctors, a specific doctor, a specific doctor that may not be wanted, a doctor whose quality rating may be above a threshold, a doctor whose dependability rating may be above a threshold, number of doctors actively logged on a health information matching system, the years of experience of a doctor, and number of doctors that are licensed in the location. The send parameter may be provided in a template, wherein the template may be applied to a plurality of health information.

An example embodiment may have read parameters, wherein the read parameter may be at least one of a type of credentialing, type of studies, time of interpretation, number to read, time period to read a study, or time period per case, minimum read price, equipment rating, clinical data rating and preferred health information providers. The read parameter may be provided in a template, wherein the template may be applied to a plurality of health information.

An example embodiment may determine credentialing, wherein the credentialing may be at least one of a license issued by a State government in one of the 50 States of the United States or one of its Commonwealth, a license issued by a foreign government, an approval by an organizational credentialing body (e.g., hospital or insurer), or a post-graduate training background.

In example embodiments, the health information may be any number of data or information that may be read or interpreted by an interpreter. For example, health information may be a various types of images, such as a medical image, an image data, a historical health information of the patient, an imaging test. The medical image is a radiology image, a pathology image, etc. The health information may also be a clinical data. An interpretation may be a preliminary interpretation or a final interpretation or may include both a preliminary and a final interpretation.

An example embodiment may also include a method of providing double readings or double interpretation. For example, an example embodiment may be a method providing the first health information and associated first interpretation by the first interpreter to a second interpreter; receiving an opinion of the first interpretation from the second interpreter; and receiving a second interpretation associated with the first health information; The method may further include providing historical health information to the first interpreter; and receiving an opinion from the first interpreter comparing the health information to historical health information, comparing the first interpretation to the second interpretation; providing the first health information to a second interpreter; receiving an interpretation from the second interpreter; comparing the first interpretation to the second interpretation; and adjusting a rating of the interpreter as a function of at least a comparison of the first plurality of interpretations and second plurality of interpretations.

An example embodiment may include an on-call group of interpreters. A method of the example embodiment may include notifying at least one of a second plurality of interpreters when a trigger event occurs, wherein the second interpreter is in a subgroup of on-call interpreters; adjusting the rating of the plurality of on-call interpreters on dependability of completing readings. A trigger event may be at least one of the events comprising a critical time window associated with a health information that still requires interpretation, a minimum number of interpreters in a health information matching system, a minimum number of specialist interpreters in a health information matching system, and a special event trigger. The adjustment of the rating of the on-call interpreter may be a function of at least one of the response time of the on-call interpreter, the total available time that the on-call interpreter spends on the system, and the total number of interpretations the on-call interpreter provides. A method may further include removing the on-call interpreter from a list of on-call interpreters when the rating reaches a trigger event. A bonus may be provided as a function of at least one of the time of day availability to be on-call, number of cases read while on-call, number of on-call days taken. Compensation may be provided to the plurality of interpreters as a function of at least a rating and a bonus.

An example embodiment may have core interpreters. The core interpreters may be interpreters that are a backup for either the general population of interpreters or on-call interpreters. A method of an example embodiment may involve notifying at least one of a third interpreter when a trigger event occurs, wherein the third interpreter is within a subgroup of core group interpreters. A trigger event may be at least one of the events comprising a critical time window associated with a health information that still requires interpretation, a request made by an on-call interpreter, a request made by a health information provider, a request made by one of the interpreters in a health information matching system, a minimum number of interpreters in a health care information matching system, a minimum number of specialist interpreters in a health care information matching system, a minimum number of on-call interpreters available to be notified, and a special event trigger. A trigger event may be the lapse of a pre-determined period of time, wherein the pre-determined period of time is one of the plurality of send parameters. A trigger event may be receiving an interpretation of the health information. A method of an example embodiment may also involve adjusting a rating upon the occurrence of the trigger event.

Health information, or other information such as articles may be displayed to users. An example embodiment may also include holding the health information provided to the interpreter in a worklist, releasing the transmitted health information from the worklist after a trigger event. In an example embodiment, a method may involve providing the health information in a generated worklist, wherein the worklist comprises health information, from the health information matching system, that is matched to the interpreter. Health information in the worklist may be populated as a function of the matching of the send and read parameters. Interpreters may select a health information from the worklist.

An example embodiment may also receive funds or charge health information providers for services rendered. A method of an example embodiment may involve any number of methods of calculating fees to be received, including: receiving a fixed portion of a difference between a matched send parameter fee and a read parameter fee; receiving a fixed transaction fee, receiving an additional fee as a function of at least one of a fixed amount of time to provide an interpretation after a health information is received by the health information exchange system, a pre-determined time of day by which an interpretation must be provided, a frame during which an interpretation must be provided, an early expiration time, a requirement for an interpretation by a specialist interpreter, a requirement for an interpretation based on the quality rating of the interpreter, and to fulfill a send parameter; receiving a fixed fee as a function of a time frame for a health information to be interpreted; receiving a fixed percentage of the difference between a matched send parameter fee and a read parameter fee; receiving a fixed fee as a function of a reimbursement; receiving a fixed fee as a function of send parameter options; and receiving a fee pre-determined as a function of market forces; refunding part of a fee to a health information provider, wherein the fee is a function of the difference between a maximum and minimum price.

An example embodiment may administer various methods of transmitting funds to the various parties involved, including: having a health information provider transmit a fee to an interpreter, wherein the fee is related to the health information; facilitating a transfer of funds from a health information provider to an interpreter; and receiving a fee from a payment from a health information provider, and distributing a portion of the fee to an interpreter, wherein the fee is related to the health information.

An example embodiment may have interpreters that are physically located and connected to servers of a health information exchange system, or may connect through a communication medium. The example method may involve receiving health information from the health information provider; storing the health information in storage in a first network; receiving a registration from an interpreter; providing the health information to the registered interpreter; receiving an interpretation from the interpreter; receiving a registration from a health information provider, encrypting the health information (including decrypting, wherein the encryption may occur at only one side, at all points of transfer over a communication system, or at specified times designated by a system administrator); notifying an on-call interpreter if a trigger event occurs; and notifying a core interpreter if a trigger event occurs. An interpreter may access a terminal that is accessible through a second network. A storage may be in a health information matching system.

An example embodiment may include a method for advertising from journals or storing older health information to use as a teaching tool An example method of providing medical information may involve receiving a plurality of health information from a health information provider; providing the plurality of health information to a plurality of interpreters; receiving interpretations from a plurality of interpreters; storing the interpretations in a storage area; associating the interpretations with a classification parameter; associating a first health information with a second health information based on a classification parameter; associating a first health information with a journal article based on a classification parameter; and assigning a teaching rating to the health information. A classification parameter may be at least one of a modality, a body part, a disease, a sign, a symptom, a diagnosis, an interpreter, a journal article. The classification parameter may be used to categorized and associated health information, articles, or other data on a health information exchange system.

An example embodiment may be used in a health information exchange system standing alone or integrated in another system, such as a hospital system, a network of health information providers, etc. An example embodiment may be a method for matching health information to interpreters, involving arranging a plurality of health information (e.g., imaging tests or the component parts of an imaging test) in a health information matching system; filtering by send parameters; filtering by the interpreter information of interpreters in a health information matching system; placing a plurality of health information into an interpreter worklist. The health information is sent to an interpreter in the order of the level of urgency. The level of urgency is a function of at least one of the time the health information was placed in a health information matching system, an urgency level indicated by a health information provider, and the amount of time before the health information expires. The send parameters comprise at least one of the licenses required to read the case, the modality, the body part of the case, and a requisite qualification of an interpreter. The number of medical information cases placed into an interpreter worklist is based on a function of at least one of the variables comprising the number of cases in the health information matching system, the number of interpreters in the system, the number of on-call interpreters available, and the number of cases in interpreter worklists or a fixed number

An example embodiment may provide second reads or quality assurance. For example, a method of providing quality assurance may involve receiving a first health information from a health information provider; providing the first health information to a first interpreter; receiving a first interpretations associated with the first health information from the first interpreter; providing the first health information to a second interpreter; receiving a second interpretation associated with the first health information from the second interpreter; comparing the first interpretation with the second interpretation; providing the first interpretation to the second interpreter; receiving a rating of the first interpretation from the second interpreter; providing the first health information to a third interpreter based on the comparison of the first interpretation and the second interpretation; and associating a rating to the interpretation as a function of the first interpretation. The second interpreter may be a specialist interpreter. The rating may be given by at least one of the health information provider, a health information matching system, and the second interpreter. The first plurality of interpretations may be a preliminary interpretation, and wherein the preliminary interpretation indicates an emergency action must be taken.

An example embodiment may be used for matching other types of information or different types of users. For example, users may be a lawyer or a research facility. An example method may involve providing medical interpretations including receiving a first health information; providing the first health information to a plurality of interpreters, wherein the interpreters are filtered as a function of interpreter qualifications and interpretation conditions; and receiving interpretations associated with the first health information from the plurality of interpreters. Interpreter qualification may comprise one of at least the interpreter's years of training, the interpreter specialty, the quantity of interpretations the interpreter has reviewed on a health information matching system, and a rating of the interpreter. The interpretation condition may be a pre-determined amount of time to interpret the health information.

An example embodiment may be to include a health information matching system, with a storage device, wherein a plurality of health information, a plurality of read and send parameters, and a plurality of interpreter profiles are stored; a processor that matches a plurality of images to a plurality of interpreters to a plurality of health information as a function of read and send parameters; a server that hosts a plurality of interpreters on the system, and a remote connection of a first interpreter which connects a terminal of the first interpreter to the host server. The example embodiment may further include a second remote connection to a terminal of a second interpreter to the host server; a health information provider server, wherein the server can remotely connect and send health information to the host server; or, an intermediary server that can receive health information and remove patient identification information from the health information. The removed patient identification information and the health information may be associated with a unique identifier.

An example embodiment may include a system for facilitating the matching of medical images to doctors, including an image server storing images; a matching server configured to match an image to an interpreter based on a send and read parameter; a host server connecting to a health information provider and a remote interpreter terminal; and a data server removing patient identification information from the images and associating a unique identification with the removed data with the image data.

Detailed descriptions of the above example embodiments may be illustrated herein.

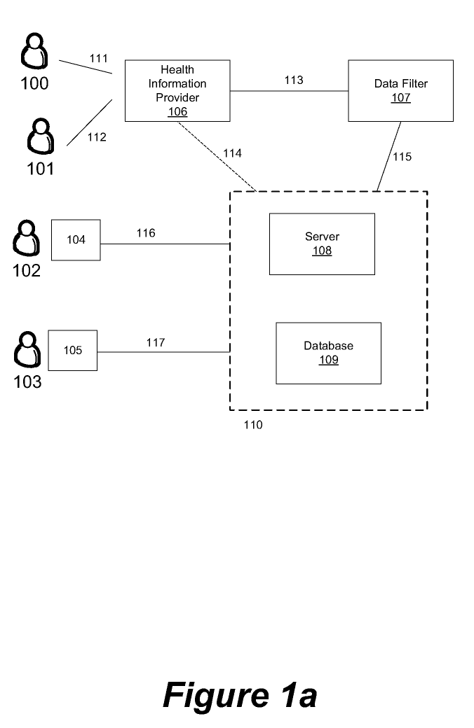

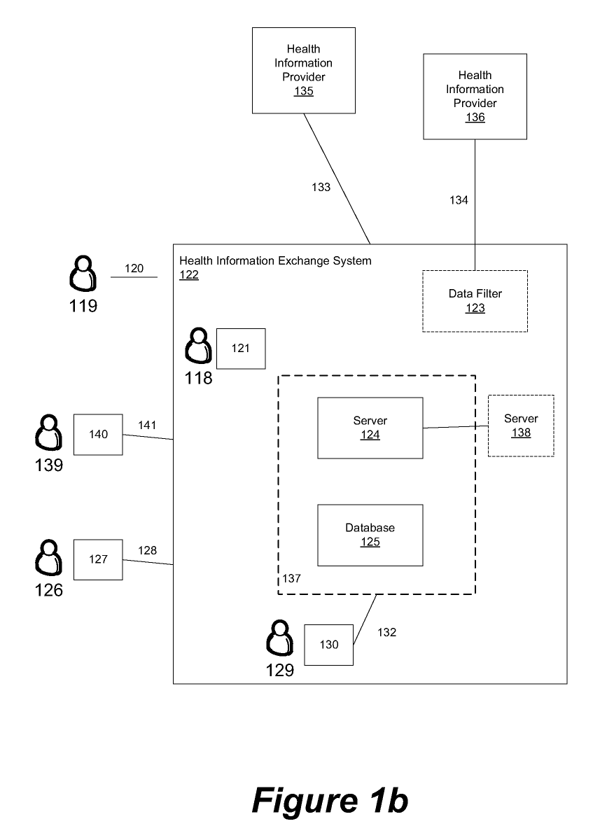

FIG. 1a illustrates a diagram of an example configuration of an example health information exchange system, according to an example embodiment of the present invention. For purposes of the example, two patients 100 and 101 are illustrated. The patients 100 and 101 have their health information obtained by health information providers 106 through a communication medium 111 and 112, respectively. The communication mediums described herein may be a modem, DSL, cable, ethernet, wireless, etc. Health information that is provided may include medical images, image data or other image information, results of laboratory tests, results of pathology tests, physical signs and symptoms, surgical history, etc. A health information provider 106 may include individual physicians (e.g., primary care physicians), a physician group, imaging test producers, hospitals, patients, lawyers, drug companies, research organizations, entities performing clinical trials, etc. The health information may then be provided to an automated health information matching system 110.

The automated health information matching system 110 may have a server 108, the server being an integrated server capable of hosting interpreters (such as radiologists, and other medical professionals providing image interpretations) connected to or integrated with a health information matching system, storing images, matching interpreters to health information, receiving connections from remote health information providers and remote terminals of interpreters, serving data of health information and removing personal identification information of the patient from the data, etc. The servers may also be separate servers with the functionality of hosting, receiving connections, serving data, and manipulating the various data between the multiple servers. The server 108 may contain the instructions to perform matching of the health information to various users including health information interpreters, and a database 109, storing the health information and user data. The stored information and matching system may be in separate systems, or they may be contained on the same system for efficiency purposes. Information from the health information provider 106 may be transmitted through a communication medium 114 directly to the automated matching system 110, or the information may first be transmitted through a communication medium 113 to a data filtering system 107 which may in turn transmit a subset of the health information through a communication medium 115 to the automated health information matching system 110.

Health information that is particularly sensitive may be filtered through a data filtering system 107 to remove patient contact information, identification information, or privacy information. The removal of sensitive information may be required by a policy of the health care provider 106, by law (as may be required by laws, such as the Health Insurance Portability and Accountability Act (HIPAA) Privacy rules, Code of Federal Regulations, such as 21 CFR part 11), or laws that require storage and audit trails for reports), or at the request of the patients 100 and 101, etc.

The data filter 107 may be able to determine which health information providers are providing the health information data and filter the data according to pre-determined criteria set by the particular health information provider.

Various entities that access the health information may do so through the health information matching system 110. Various entities that acquire health information may include a user 102 or a specific type of user, such as an interpreter 103, which may connect to the automated health information matching system 110 through a communication medium 116 and 117, respectively. Users 102 and interpreters 103 may have an interface 104 and 105, respectively, of a web application provided on a terminal, PDA, laptop, desktop, or other available computing device, or in other embodiments the automated health information matching system 110 may be directly integrated with the interface with information being downloaded from the server 108 or database 109.

FIG. 1b illustrates another example configuration of an example health information exchange system, according to an example embodiment of the present invention. A health information exchange system 122 may contain the instructions needed to facilitate a health information matching system 137 integrated into the health information exchange system 122. A server 124 may host the health information matching system, store images, host a plurality of interpreters, patients, and users, etc. The health information provider may receive information through a communication medium 120 from a patient 119, or the patient 118 may input the information while at a terminal 121 of the health information exchange system 122. Likewise, a user 126 may access the health information provider 135 and the health information exchange system 122 through an interface 127 connecting through a communication medium 128 (which may be a direct connection, a connection through an intranet, a virtual private network, a connection through a internet, or other variations or combinations, etc.). An interpreter 129 may also be at the health information exchange system 122 and access through a terminal 130 directly connecting to the health information matching system 137 through a communication medium 132. Or an interpreter 139 may connect from a remote terminal 140 through a communication medium 141. The server 124 of the health information matching system 137 may be an integrated server of the health information exchange system 122, or may be a separate server, which would communicate with a separate server 138 of the health information exchange system 122.

A health information exchange system 122 may contain a database 125, in this example integrated with the health information matching system 137, to store information and this may be integrated or separate from the server 124. A health information provider 135 may be able to communicate with other health information providers within the same medical system through an internally secured communication medium 133. However, the health information exchange system 122 may also be able to share information with health information providers 136 outside the medical system through a communication medium 134 and this information may have sensitive information removed first through a data filter 123.

In example embodiments of the present invention, the health information exchange system may be located in an intranet, or accessible over a network. For example, a health information storage may be located in a first network, and accessed over a communication medium by an interpreter on a second network. The interpreter may access the information on a terminal displaying an interface. The storage, health information exchange system, and the interpreter may be on three separate networks, or may be all in the same network, or any combination thereof. The interpreter and health information provider may also access the health information exchange system over a communication medium, wherein all the participants to the health information exchange system are not physically located in the same location. The health information data may also be encrypted. This may be because the information is traveling out of an intranet and patients may require greater security.

A health information matching system or a health information exchange system may also be arranged within a health information provider, such as a hospital. The health information provider may be part of a greater network of health information providers, each with a health information matching system. The health information matching system may distribute health information to interpreters in the order of the level of urgency, and these interpreters may be within the network of the health information provider. The health information may be medical information cases placed into interpreter worklists. The worklists may contain actual copies of the health information, the original health information data transmitted from the health information, or pointers or links to the health information in databases or servers. The number placed into the interpreter worklist may be based on variables in the system, or may be a fixed number.

It may be appreciated that the various elements of the health information providers, data filter, health information matching system, and the various methods of communication by the patients, users, and interpreters, may be situated in different configurations.

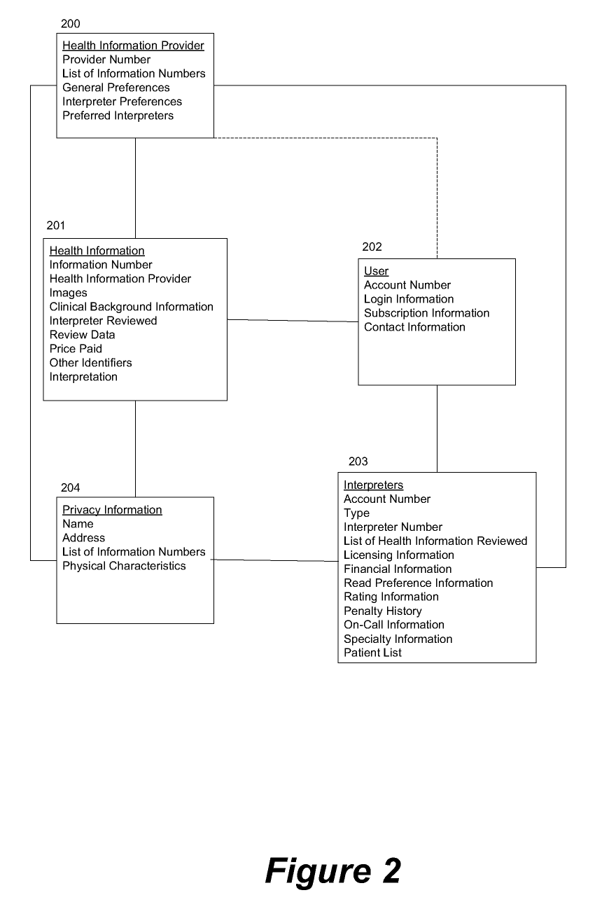

FIG. 2 illustrates an example data structure of data stored in connection with a health information exchange system, according to an example embodiment of the present invention. Data may be stored in various data structures or tables within a database depending on the arrangement of the matching and account system. For example, Users 202 may be interpreters, doctors, medical students, other users interested in medicine, government officials, and patients. Users may be associated with several health information data, and there may be either the actual health information data stored within the user table, or there may simply be links or pointers to the health information data. One possible example data structure arrangement may have five main categories: Health Information Providers 200, Health Information 201, Users 202, Interpreters 203, and Privacy Information 204.

The lines connecting the data structures represent lines of access between the various data structures. For example, a user 202 would not necessarily require direct access to the health information provider 200, but may require direct access to the health information 201 provided by the health information provider 200. The user 202 may, in some example configurations, have access to the health information provider information in order to obtain clinical information, old images, etc. It may be appreciated that the levels of access may be altered by the system administrator based on the various factors, for example, the level of security, the organization of the data structures, and the number of expected participants in the system, etc. It may be further appreciated that related data may be stored in the data structures, copies of the data may be stored, or links to related data may be stored.

In a Health Information Provider 200 data structure a unique provider number may be associated with each provider of health information. The providers may be imaging centers, but they may alternatively be academic researchers seeking to have large amounts of blinded information clinically diagnosed, hospitals seeking to have images read or having images double-read for quality control, lawyers seeking to have images read in order to survey a potential malpractice suit, etc. A list of Information Numbers may be stored, wherein the information numbers may be the unique identifier of each health information data, which may be an individual patient case or a series of related cases of a single or a group of patients.

Health Information Providers 200 may also store General Preferences and Interpreter Preferences. General Preferences may be any type of preference a provider may associate with a health information data, a group of health information data (e.g. a group of health information listed at night, or a group that is listed during the day, etc.), a group of health information types (e.g. all CT scans, or all scans for a certain body part, etc.), or a preference for all health information data that the provider may place on the matching system database which the Health Information Provider may use later to match the health information with interpreters. Interpreter preferences may be preferences for doctors of a certain type of specialty. Preferred Interpreters may be specific names of interpreters 203, or, if the interpreter 203 is blinded to the health information provider 200, then the identification number of the interpreter 203. The preferred interpreters may also be interpreters that the provider would prefer in relation to other interpreters of equal level, or that the providers would pay a premium to have interpret the health information.

In a Health Information 201 data structure, a unique Information Number may be stored that may identify the specific health information of a patient, related diseases, etc. The Health Information Provider 200 from where the health information originated or where it has been supplied to may also be stored. Images associated with the health information 201 may also be stored along with Clinical Background Information. Review Data, which may be the specific interpreter or interpreters that reviewed the Health Information, may also be stored. The price(s) paid for the reviews may also be stored and associated with the doctors that reviewed the Health Information 201. Other unique identifiers may be included for extra functionality, such as enhanced searching. Such unique identifiers may include unique identifiers for the patient, each patient test, and each image for each test, etc. that are related to the health information. The interpretation, final or preliminary, may also be linked or stored in the health information data structure.

In a User 202 data structure various account information may be stored, such as Login Information, Contact Information, etc. A unique Account Number may be assigned to individual users. A user data may also store various Subscription Information, such as to journals or articles that were purchased from the health information exchange system. Users of the system may be interpreters 203, doctors, medical students, researchers, lawyers, people in the medical field, etc.

In an Interpreter 203 data structure there may be a unique Account Number. The interpreter may be a doctor, and hereinafter, a specific type of interpreter may be referred to as a doctor, even if the doctor does not specifically interpret health information on the particular health information exchange system. This Account Number may be the same Account Number if the interpreter is a user 202 because all interpreters 203 may be users 202, but not all users 202 may be interpreters 203. Thus, the interpreter information may be linked through the same unique Account Number. The doctor may also have a unique Interpreter Number.

An interpreter may be one of several types. An interpreter may be a general interpreter, which is the basic level of interpreter in the system. The general interpreter may be a doctor qualified to read and provide interpretations for health information that does not require special qualifications. Another type of interpreter may be a subspecialist or specialist interpreter. These interpreters are interpreters that have the credentials to read a higher level of health information. For example, some health information may require a radiologist with additional subspecialty training, such as a neuroradiology fellowship. Another interpreter type may be an on-call interpreter. These on-call interpreters may be one of the other types of interpreters and are designated as on-call if they volunteer to be ready to interpret during specific hours that they are on-call. In return for their availability, the health information may provide extra bonus points or financial compensation. A core group of interpreters may be another type of interpreter that serves as a back-up to the on-call interpreters. The core group may also share attributes of the other types of interpreters, such as having a subspecialty. The core group may also serve as system administrators, or special interpreters that act as referees for second reads. This will be explained in more detail below.

A list of all the Health Information that the interpreter reviewed may also be stored. Licensing Information of the interpreter may also be stored, for example, the states where an interpreter is licensed as well as license and registration information, the hospitals at which the interpreter currently or previously held privileges. Any professional records that are accessible to the public may also be stored. For example, an interpreter's public information may automatically be retrieved and accessed based on the interpreter's license or registration number within each state where the interpreter is licensed or registered. Financial Information may also be stored in the interpreter's account. This may include any bank accounts or accounts of financial institutions where the interpreter's payments for interpretations may be deposited. In addition, tax information may also be stored with the payment information. Read Preference Information containing the doctor's preferences for readings, such as the types of modalities (e.g. Magnetic Resonance Imaging (MRI), Computed Tomography (CT) Scan, X-ray, Fusion Imaging, Ultrasound, etc.), the body parts (e.g. chest, leg, etc.), the minimum price for interpretation (e.g., sorted by modality, or body part), etc. Rating Information may also be stored with the doctor information. Interpreters may be rated in various categories including the quality or dependability of the interpretations, timeliness of interpretations, availability for on-call interpretations, dependability of being on-call, etc. Penalty History may also be recorded, which, as will be explained later, also affects how a doctor may be rated and matched. A patient list may also be stored, which is a list of all the patients for whom a doctor has made interpretations, but also all the patients associated with the doctor, even if specific interpretations for that patient have not been made on the system. This may include information that the doctor may list himself.

On-Call Information may also be stored. This may contain the times of which an interpreter may be available to be on-call, the days of the week, holidays, the premium that an interpreter would increase the minimum read price to be on-call, and other special read preference information that may be altered for an on-call situation. Specialty Information concerning the interpreter's various specialties may also be taken into consideration during the matching process, for example, if an interpreter was a doctor that did a fellowship or had other special training or experience. Explanation of how an interpreter may be qualified as a specialist will be explained later. Some information may be provided by the interpreter while other information, such as licensing, complaints, or other public information may be automatically culled from various third party databases to create a complete profile of the interpreter. For example, a doctor may provide various articles that he or she has written, studies that he she has participated in as an investigator, etc.

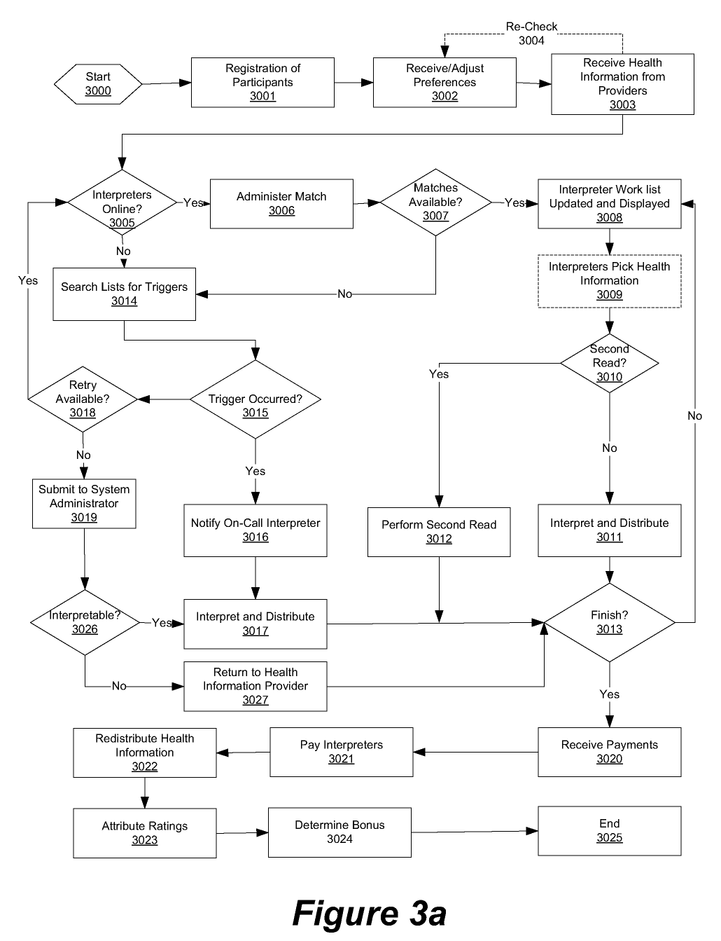

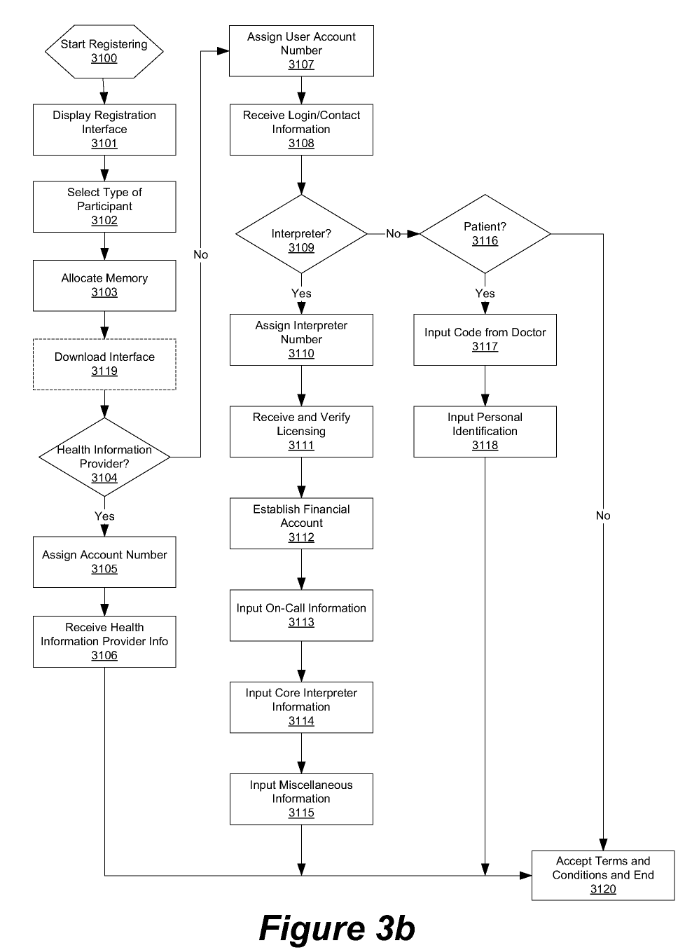

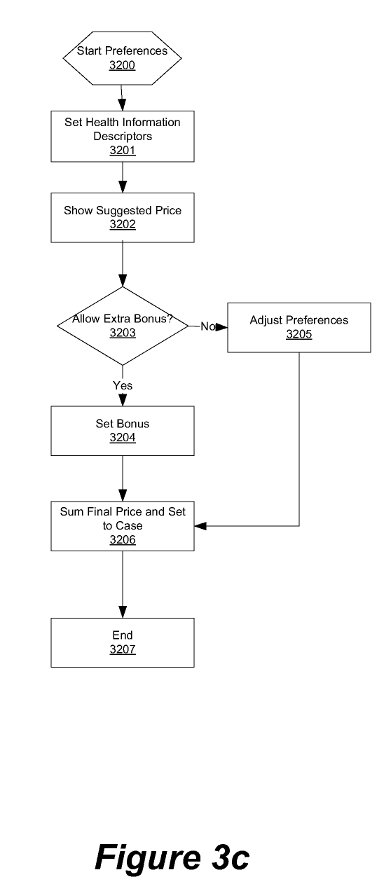

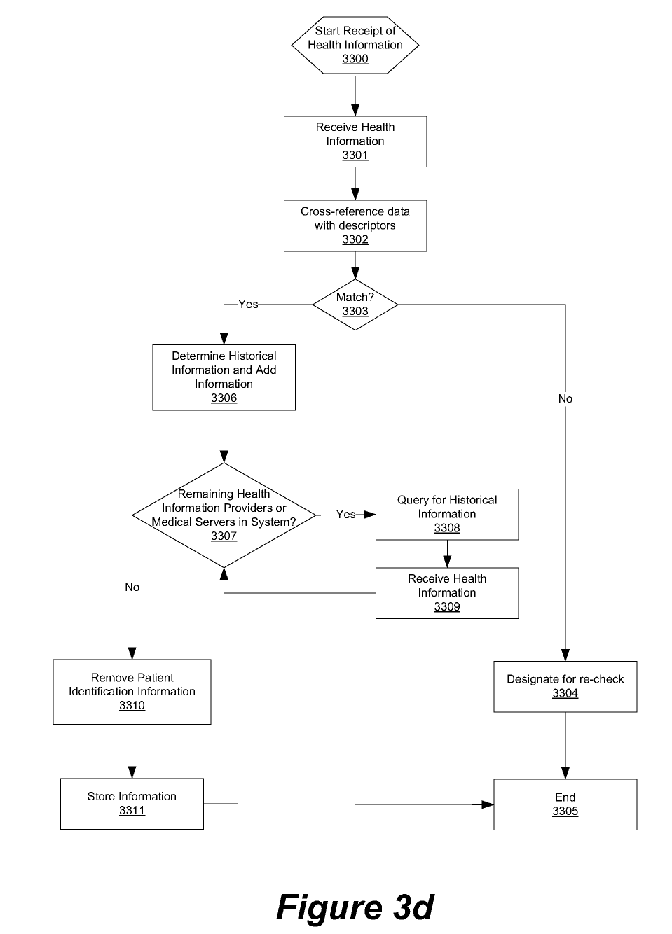

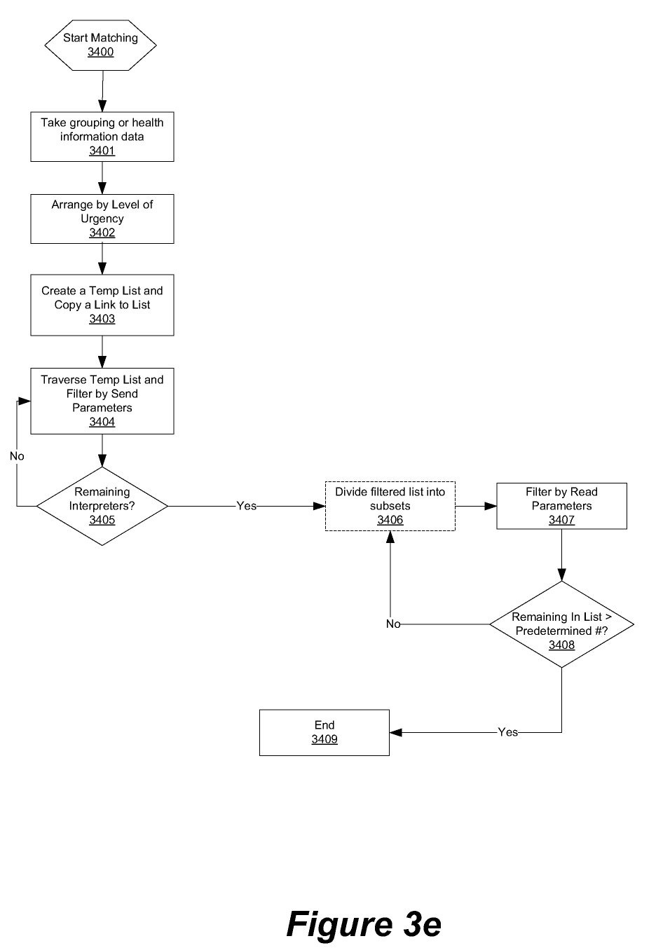

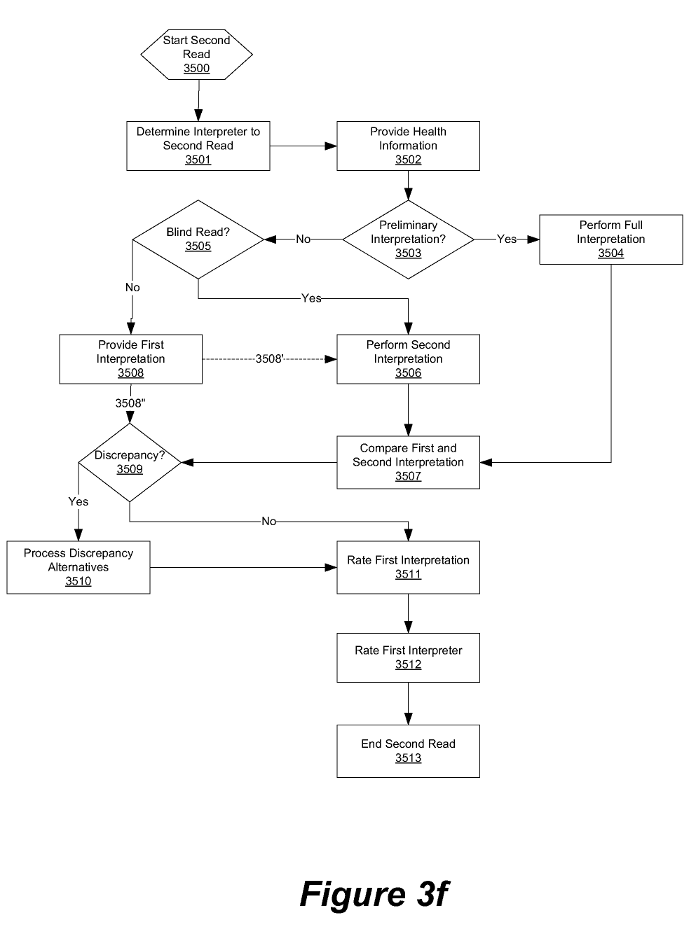

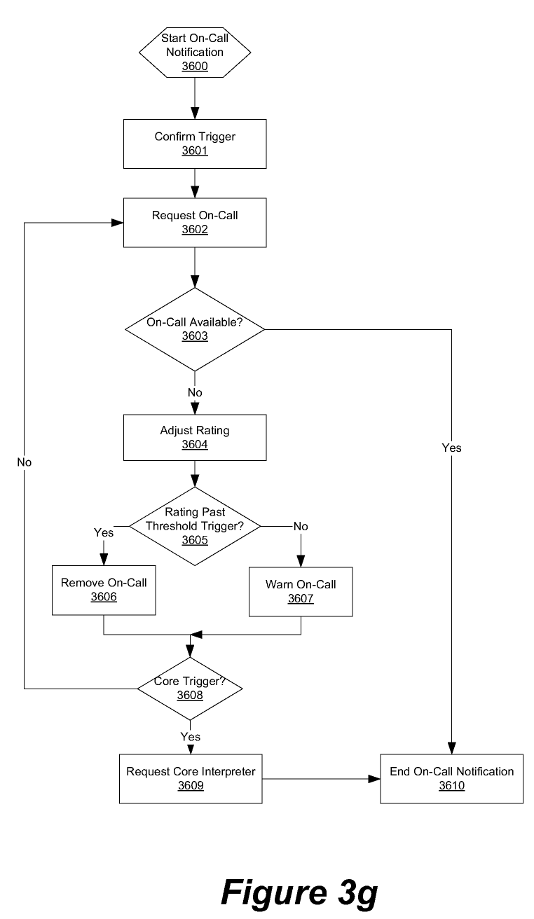

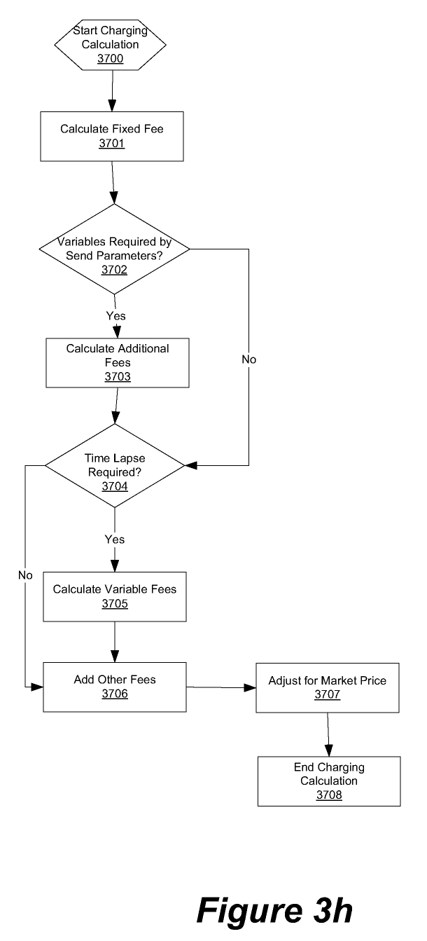

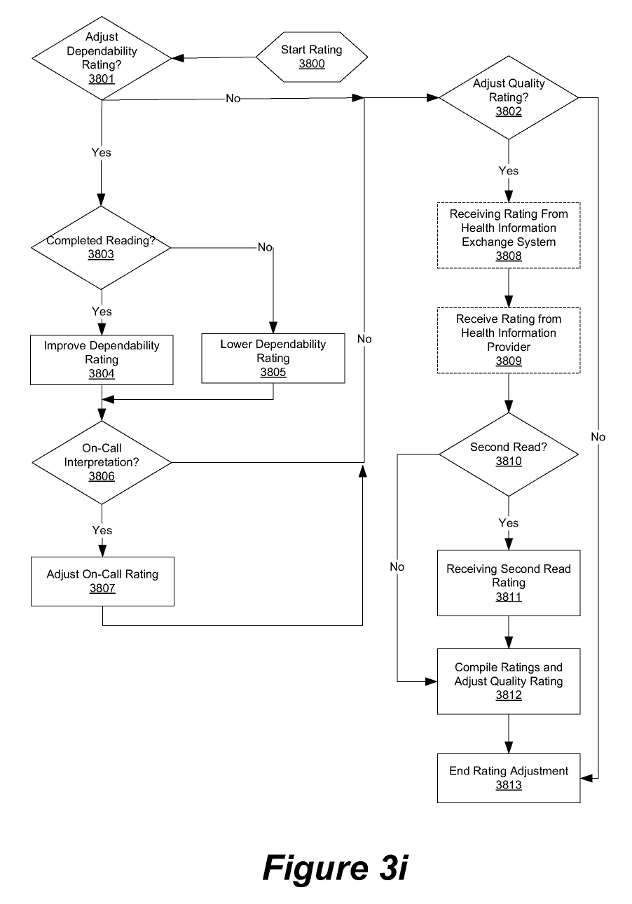

FIGS. 3a to 3i illustrate various example flowcharts of an example procedure for creating an account and matching health information in a health information matching system of a health information exchange system to be read by and receive an interpretation from an interpreter. In the example embodiments provided, the health information matching system is integrated with the health information exchange system and reference to one may be interchangeable. However, as explained above, functionality of the health information matching system may be separated from the health information exchange system, or may operate in conjunction with the health information exchange system. Readings and interpretations may also be used interchangeably to describe the information provided by interpreters.

FIG. 3a illustrates a flowchart of an example system of registering users and health information providers to a health information exchange system and matching health information to interpreters, according to an example embodiment of the present invention. At the Start 3000, the system may be initiated to register Participants 3001 to the health information exchange system to populate the databases. Participants to the health information exchange system may be users, interpreters, doctors, etc. Participants may also be patients that wish to view their results. Patients may be given temporary or permanent access to such results depending on the discretion of their doctor or the health information provider or according to the applicable law. Participants may also be Health Information Providers that may send health information either directly or through a third party, and this data would also be stored in the database of the automated health information matching system. Explanation of the registration process will be further explained in detail in FIG. 3b.

In 3002, because the receipt of preferences may be more complex, it may not be in the typical registration process. This may also be because this information is in a constant state of flux, either because of the change in the list of interpreters, but also the season and location of where most of the health information is being interpreted. The health information exchange system may try to adapt preferences as much as possible to adjust changes in price to market forces, e.g. the number of available health information providers or the number of interpreters available on the system. The system may receive preferences from all the participants and adjust preferences to indicate to the participants the reasonableness of those preferences. For example, a health information provider that may only want to pay $20 for any reading may receive a warning that this is not possible on the system, or alternatively, the system may have a minimum price that is being accepted based on the market for that month, year, season, etc., adjustable at the discretion of the system administrator. Moreover, depending on the quantity of cases, the health information exchange system may allow for exceptions to some preferences, such as the minimum read prices. This may also be because of a contract created between the health information provider and the health information exchange system, in which the system administrator may provide a code to override the system's typically automatic adjustment of preferences.

Depending on the type of participant, preferences added may be send parameters or read parameters. These preferences may be used in the matching process to filter out health information that should not be matched from a particular participant or to a particular participant. Health information from participants, such as health information providers, may be filtered using send parameters. Health information to particular participants, such as interpreters, may be filtered using read parameters. Send parameters and read parameters may be stored as preferences in a database of the system. In other example embodiments, storing may be in temporary storage, such as RAM or parameters that are placed in the system only to be deleted after the health information is matched.

In some instances, a doctor or interpreter may want to put health information data on the system to be interpreted. This may be done because a patient wants a second opinion. Another reason may be because a doctor located in a foreign country may not have the expertise or experience in a particular specialty or organ system and wants a specialist to review the health information data as a precaution. In such instances, those participants may also provide send parameters and would temporarily also be designated as health information providers in the health information exchange system. Because these temporary providers may have fewer resources, they may be allowed to alter the send parameter limitations at the discretion of the system administrator.

Send parameters may be set for all types of health information, or they may be set for each health information data submitted, or groups of health information. For ease of processing from health information providers that may have large quantities to transmit, templates may be created that may be assigned to set preferences based on various factors, such as specific types of health information data or times of the day that a health information is provided. The send parameters may also be provided by the health information matching system. For example, the health information matching system may have default templates for various types of health information data with, according to market forces, the best price for the highest and most efficient read currently on the system. This may also be constantly changing, or only change over the course of a day, week, month, or data available through a year or even longer depending on the system administrator. The health information matching system may also not allow some send parameters to be set or altered unless the health information provider has been a long-term or bulk provider. In such an instance, some of the send parameters may be set by the health information matching system with the other send parameters provided by the health information provider. The health information provider may be able to provide or save settings such that when its status changes the health information provider's own settings would replace the default settings. The administration of send parameters associated with a health information data is explained in more detail in the example provided in FIG. 3c.

There are various send parameters, some of which are set by the health information matching system which may be altered by the health information providers, others which may be specially requested to be added by the health information matching system.

One example send parameter may be the time frame during which a health information data may be read by an interpreter or for which the health information provider is to receive an interpretation. Thus, the time frame may be set to the time from which a health information is first released to the health information matching system, the total time that the health information is on the system, or the latest time that the interpretation of the health information may be placed on the system. In addition, while a health information may be placed in the health information exchange system at one time, a health information provider may choose to have the actual health information data released and available to be matched and in worklists at a later time in order to take advantage of the flux in the interpreters that are online. For example, a health information provider may have a bulk of health information data to load onto the system in the middle of the night, but from historical data it may know that less interpreters are on the system at night and it would be likely that on-call interpreters may be required to be used for such a large bulk of data. In this example, the health information provider may choose to have the health information released to be matched at a later and/or specified time during the day. In some instance, the health information provider may allow the health information matching system to help to maximize the efficiency by releasing the health information onto the system at the expected time that will peak in the number of interpreters. In this example, the health information provider may indicate a deadline by which it requires interpretations and the maximum time that the health information should be in the system before it pays a premium for paging on-call interpreters.

The time frame may also be the desired turnaround time, and the health information provider may set the increments of time, such as 15 or 30 minute increments. The desired turnaround may also be a function of the time of the day. The desired turnaround time would depend on the local time of day. For example, a health information provider may specify a 4 hour turnaround time for studies sent between 7 am and 1 pm local time. That way, all of their studies sent by 1 pm local time would be read within 4 hours with the latest at 5 pm. Health information providers may specify a sliding scale so that all studies sent by 3 pm are read by 7 pm (meaning that a study sent at 2 pm would have 5 hour turnaround time and a study sent at 3 pm would have a 4 hour turnaround time, etc.) For example, health information providers that performed scans until 10 pm at an outpatient center may decide that any study done after 5 pm could be read by 10 am the next morning. That would mean a 17-hour turnaround for a study sent at 5 pm; a 15 hour turnaround for a study sent at 7 pm; etc. If the price paid to the interpreter increased slightly but incrementally based on the age of the study for a desired turnaround, then health information providers may have an incentive to send studies as soon as they are performed.

Another example send parameter may be the range of price that the health information provider is willing to pay. The minimum prices that the system may allow may be automatically adjusted, as explained above and will be explain in more detail later. The minimum price may also change depending on the type of health information data that is being read. The minimum price may also be a function of other send parameters. For example, if a send parameter indicates that the health information must be interpreted by a specialist or by an interpreter with certain qualifications, the minimum read price may be adjusted to a higher price if there are no interpreters with the desired specialist qualifications on the system willing to read below a certain price.

Another example send parameter may be the location of the health information where the final interpretation is being provided. This may depend on the specific laws of the state or country that provides the health information. For example, the send parameter may require that the interpreter be located in a specific location, such as only doctors located in the United States. Another example may be a requirement that the interpreter or doctor received training or is licensed to practice in a certain jurisdiction, a state, country, etc. For example, in the United States, Medicare will only make payments for work performed in the United States. Moreover, the location may automatically alter the minimum prices because if a specific obscure location is desired, few doctors may be licensed, and thus the number of doctors licensed in the location may alter the minimum price.

Another example set of send parameters have to do with the qualifications of interpreters desired. A send parameter may be specific credentialing of the interpreter. For example, a send parameter may require that the doctor required must be a radiologist, or even more specifically a radiologist with a pediatric specialty or other radiological subspecialty, such as abdominal imaging, mammography, cardiac imaging, gastrointestinal imaging, genitourinary imaging, magnetic resonance, musculoskeletal imaging, neuroradiology, nuclear radiology, thoracic imaging, vascular/interventional imaging, PET/CT imaging, etc. Or, there may be a preference for doctors that have had a fellowship or special training in a certain body part. A send parameter may also be the number of years of experience of the doctor as well as the number of years of experience in the particular specialty.

Another example send parameter may be qualifications internal to the health information exchange system, such as particular ratings of the interpreters. This may be a minimum threshold of the dependability rating of the doctor or the quality rating of the doctor. These ratings will be explained further below.

All other send parameters being equal, the send parameter may also specify particular interpreters in the system, either requesting a specific group of doctors, a specific doctor, or a specific doctor that is not wanted. For example, a doctor from a particular radiological practice group with a good reputation in the medical community may be desired. As another example, specific doctors with a good reputation may also be desired, and conversely, notoriously bad doctors may also be disqualified from readings for a particular health information provider. Or, if a health information provider had a particular bad experience with a specific interpreter's readings, the health information provider may exclude the interpreter from future readings by listing the interpreter's interpreter number in the send parameters.

Another example send parameter that may affect the minimum price may be the number of doctors actively logged on a health information matching system. This may be culled from historical data and may be altered over time at various intervals. Thus, the price may depend on the exact moment that the health information may be available, or the general time of day, down to the specific hour, minute, or second. Data may also be determined over the various days of the week, the holidays, and peaks and lows during the months. Over a longer period of time, the minimum price may be adjusted to determine the market for readings based on the time that a health information is likely to be read due to the number of doctors estimated to be on the system. In order to do this, the health information exchange system may track demand (i.e. the number of health information typically added to the system) and supply (the amount of new doctors registering, available to be registered, and exact times that a health interpreter is using the system). The health information exchange system may also track the efficiency of each interpreter, including the number of interpretations provided by each interpreter, and the time per interpretation. The system may also track the times of day that each individual interpreter is on the system and collate this data to calculate peak and low times, adjusting the minimum price accordingly. The system may also calculate this data in particular for certain quality ratings, specialty ratings, and other qualifications.

Read parameters may be provided by interpreters indicating preferences for the types of health information that they would like to see in their worklists. For example, some read parameters may be related to the interpreter's qualifications, such as a type of credentialing. For example, an interpreter may have a fellowship in a radiological subspecialty or be a member of a radiological society. Another example read parameter may be the type of study. The type of study may be divided into various factors, such as the imaging modality or the body part, such as the skull, face, sinuses, neck chest, abdomen, pelvis, upper extremity, lower extremity, etc. The type of study may be specified or determined by the American Medical Association's Current Procedural Terminology (CPT) coding system using individual codes or groups of codes grouped by modality or body part or some other logical grouping.

Another example read parameter may be the time of reading, in other words how often the interpreter may receive new health information in a worklist. This may initially be set to instantaneous, meaning once a health information is matched it is immediately available for review by an interpreter. However, this may be altered so as not to inundate an interpreter's worklist, and also to prompt interpreters to choose health information that is available first before choosing newer health information to review. Another read parameter may be the time period to read a study, meaning the maximum or minimum time that a health information may be listed on an interpreter's worklist before it is taken off and placed on another interpreter's worklist. While the health information may be matchable to an interpreter, not all health information that may be matchable may necessarily be placed on a worklist. If there is a particularly large volume of cases in the system, in order to ensure that the work is evenly distributed so that interpreters are efficiently utilized, some health information may be placed for one subgroup of interpreters, while other health information may be placed with a separate subgroup with no overlap. However, if an interpreter knows he will not likely get to a specific health information that has been on the list after a certain time period, then the interpreter is passing up on the opportunity.

Another example read parameter may be the number of cases to read. The default number of health information to read may be set to only one; however, an interpreter may choose to lock down several health information at a time. Once locked down, the interpreter may run the risk of not having the time to read the health information or provide an interpretation in time, and this may decrease the interpreter's dependability rating. The effect of the alteration of the interpreters ratings will be explained later. In particularly high volume situations, the health information matching system may require a higher default number of health information to be read in each session.

Another example read parameter may be the time period per case, meaning the time period needed to provide an interpretation. For example, as a health information lingers and ages in the system, if there is less time remaining it may disappear from interpreters' worklists that require a longer time to read and be placed into worklists of more efficient interpreters that may be able to get the health information out of the system quicker. This may not necessarily reflect on the quality of the interpreter, but rather, the comfort level of each interpreter in the time that interpreter may want to have to read and provide an interpretation.

Another example read parameter may be the minimum read price. The automated matching health system may provide a default minimum read price that would allow the interpreter the maximum number of opportunities to read health information, given the currently available send parameters of the health information on the system. The health information matching system may also provide alternatives, such as estimated minimum read prices, using the historical data similar to above, for the minimum read prices to maximize the price per number of cases, price per time of reading, price per type of case that the interpreter desires to read, and allow the interpreter to choose from these estimated defaults. The automated health matching system may allow the interpreter to change only once (or some other fixed number of times) per day and only at certain specified times or time intervals that may vary and depend on the time of login or other factors. This may be to prevent the interpreter from “cherry-picking” cases to modify the minimum read price so that he only reads the most expensive cases. However, in other situations, for example, where the system is overloaded, the system administrator may allow users to modify their minimum read prices more than once. The system may also allow the interpreter to set the specific number of health information that an interpreter wants to read for a particular session or for all sessions, and the health information matching system would then maximize the minimum price the interpreter would receive.

Another example read parameter may be an equipment rating. For example, MRI scanners may be rated based upon field strength or minimum or maximum field strength; CT scanners may be rated based upon the number of rows of detectors, minimum section thickness; Ultrasound scanners may be rated based upon transducer frequency or type; all scanners may be rated by manufacturer. An interpreter may desire to have a minimum equipment rating because the quality of images or health information may affect the ability of the interpreter to provide an accurate interpretation. Or, it may take longer to read health information due to the poor quality of images or data produced by equipment.

Another example read parameter may be a clinical data rating, such as prior examinations, prior images, notes from prior interpreters, etc. The clinical data rating may be a function of the amount of data in a health information or may be provided by the health information matching system, the health information provider, or by other interpreters that may have reviewed the health information or provided interpretations for the health information.

Another example read parameter may be preferred health information providers. Just as health information providers may have preferred groups, interpreters may have preferred health information providers. For example, an interpreter may know that a health information provider provides the best quality health information or images and pays the best.

Interpreters may have the option of providing templates to choose read parameters for each session, different days of the week, or times of year and save these templates. The interpreter may then have a default template with saved read parameters or choose a different template upon logging into the health information matching system.

The send and read parameters may not all have equal weight in terms of filtering of health information from worklists. The health information matching system may dynamically alter the importance of the weighting based on several factors. For example, if an interpreter receives no health information in his worklist, the health information matching system may adjust the weight or eliminate some of the less important read parameters, chosen either by the interpreter or determined by the health information matching system. Alternatively, some of the send parameters may be adjusted if the health information is not being directed to any worklist or to a specified minimum number of worklists. The send parameter to eliminate or decrease in weight may be chosen by the health information matching system or the health information provider. A health information provider may also be prompted to alter the data or send parameters if the health information cannot be matched. For example, if the equipment rating of a health information provider is below the quality that any interpreter would read, the health information matching system may prompt the health information matching system to alter its send parameters.

If interpreters are not receiving health information in their worklists, or if health information providers are finding they are not having interpreters reading their health information, they may have the health information matching system set send and read parameters. The health information matching system may be set to maximize the fairest price and time of reading of cases for both the interpreter and the health information provider.

In 3003, the health information associated with the preference is transmitted and stored in the health information exchange system to be matched in the health information matching system. In 3003, health information to be interpreted would be received from the health information providers. The receipt of health information is explained in more detail in the example provided in FIG. 3d.

In 3004, a re-check on the preferences may be performed. This may occur if the health information providers described by the health information does not match data parsed from the health information by the health information exchange system. The health information exchange system will have designated which health information to recheck in 3003, otherwise, the health information may be designated as proper to proceed to be matched in 3005. If adjustments are needed in the price or send parameters, they may be re-performed in 3002 and would likely pass through the second time in 3003.

Once the automated matching system is populated with health information and participants on both sides (e.g. interpreters to interpret health information and health information providers to provide health information and receive interpretations), the matching system may commence. The registration of participants, the logging in and off of participants, and the receipt of health information and corresponding interpretations would be continuously occurring while the health information exchange system is hosting.

In 3005, the health information matching system would first determine whether there are interpreters online. If there are interpreters online, in 3006 the system would attempt to administer matches, which will be explained in more detail in FIG. 3e.

In 3007, if the health information may be matched to interpreters, in 3008 the health information is placed into the worklists of the interpreters, which may be displayed when the worklists are periodically updated. Updates may occur when the interpreter first logs onto the health information exchange system, at fixed time intervals, when an interpreter presses a refresh button on an interface, or when a new health information is placed in the interpreter's worklist.

There are various ways that a health information matching system may implement a worklist update. In one example embodiment, health information that is matched to an interpreter may automatically be placed in a worklist queue, and the interpreter has no choice in which health information to interpret. This may be an ideal setting when there are not many interpreters in the system or online at the time because the most subjectively attractive cases to interpret may be frequently chosen over the least attractive cases, and those less attractive cases may linger on the system for a long time. In an alternative embodiment, interpreters may be able to view a worklist and choose which health information cases to interpret, such as in optional 3009. This would be available if there were many interpreters in the system because it would be unlikely that many health information would linger on the system for too long.

In an alternative hybrid embodiment, both options above may be implemented. One example implementation may be to have health information automatically queued for the interpreters to read. If a certain threshold of interpreters was available, the matching system would be switched so that interpreters would be allowed to choose subsequent health information cases to read. Another example implementation may be to have a worklist where interpreters may pick health information cases. If a case were to linger on the system, or if a preference were matched, or if a trigger was activated for a health information to be given priority (e.g. if a certain amount of time elapsed since the health information was first posted, if a certain amount of time was left before the health information expired, meaning was required to be interpreted, etc.), other cases may be removed from the list or a priority case may be identified by some indicia (e.g., a color coding) or a bonus may be offered for a priority case.

There may be many ways that an interpreter may have health information displayed for an interpreter to choose. The health information matching system may facilitate the choosing of health information by steering an interpreter to pick the health information that has been in the system longest.

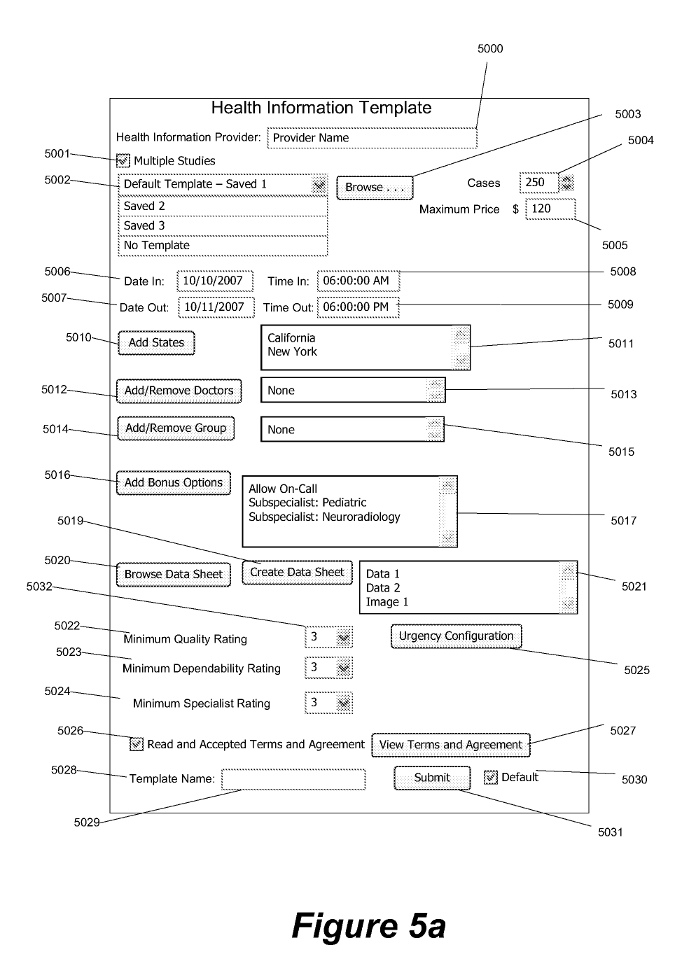

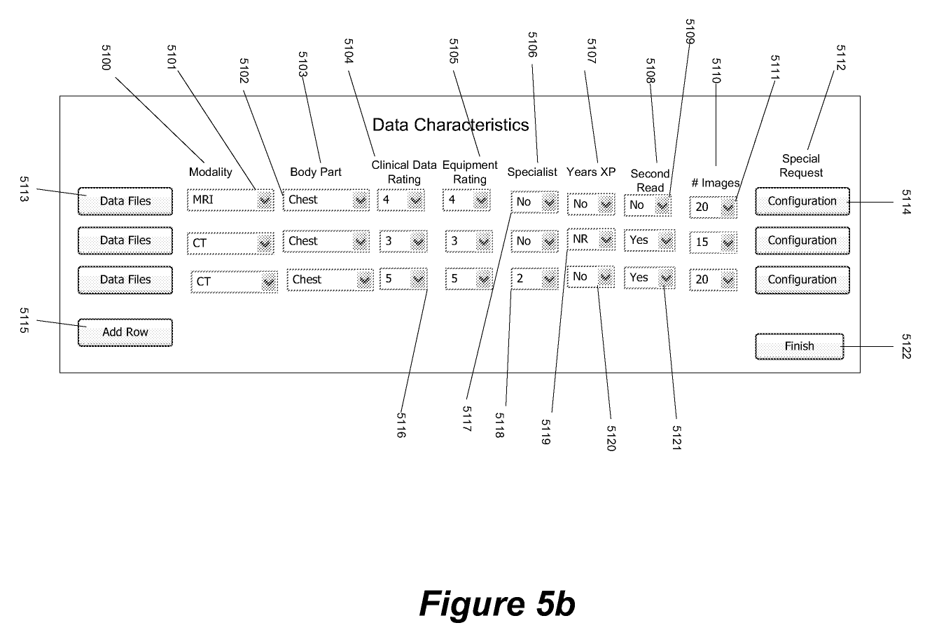

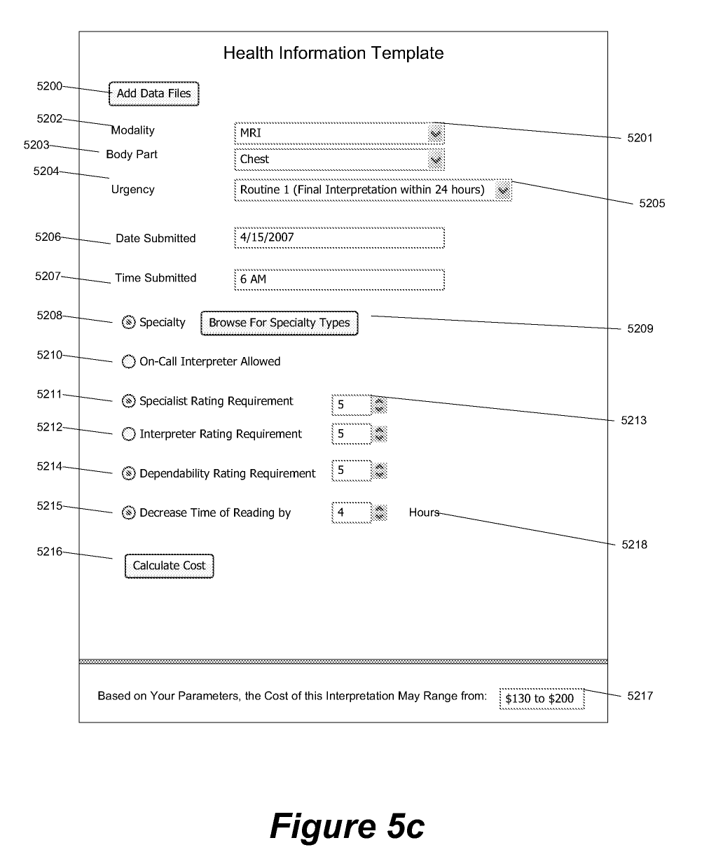

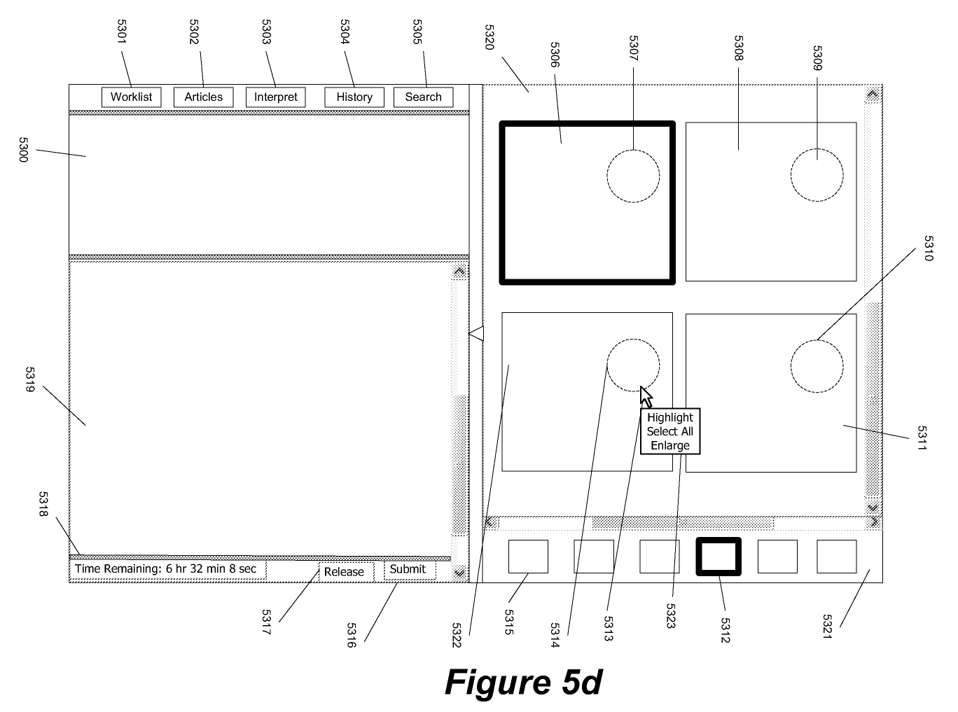

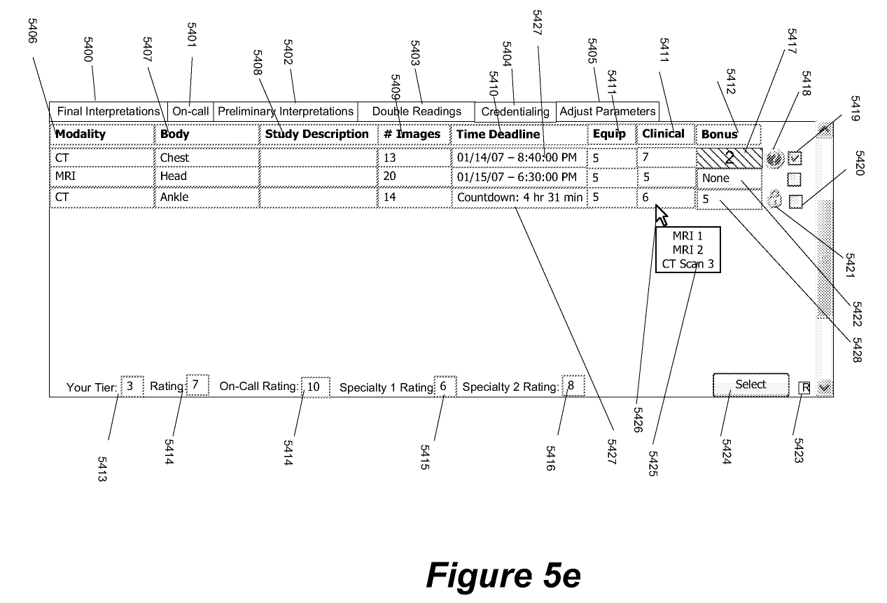

The actual display may also help an interpreter choose which health information to interpret. This may be further explained in the example interface in FIG. 5e. The health information may be shown with an associated parameter, either a characteristic of the health information or a send or read parameter previously chosen. For example, health information may be shown in a list with some of the characteristics of the health information, such as the modality, body part, the study description, the total number of images in the health information, the equipment rating, and the clinical data rating. Information relating to the health information in relation to the health information exchange system may also be shown, such as the time urgency, bonus points, and an indicium (or multiple indicia). The clinical data rating may indicate that non-image information is available, and the quantity of historical information that is available. The time urgency may be represented in the form of a time stamp of receipt, or in the form of a clock ticking down until the time that it must be read. Bonus points may also be indicated for the health information, indicating a certain point scale that interpreters would accumulate for reading the study. This may be for a number of factors, such as reading urgent studies.

As a health information ages in the system, bonus points may increase, but indicia, such as color-coding may also be displayed. For example, a simple coding system may be based purely on urgency, where green may represent a new health information, yellow is a slightly older health information, and red may represent that health information urgently needs to be read or that an on-call interpreter may need to be paged. The bonus points may reflect this color scheme where an interpreter may receive zero bonus points for a green study and bonus points as the study ages from yellow to red.

In relation to time, the health information matching system may require that a certain time field be displayed. The health information that is displayed may appear or disappear from the worklist as a function of time. For example, the health information may start aging from the time the health information is sent by the health information provider. For some health information, the time function may count from the time the health information is actually received and processed by the health information exchange system. Health information may also age as a function of time in relation to the time by which an interpretation must be provided. As explained earlier, a health information provider may want to take advantage of the different times of day when interpreters are online in order to avoid paying premiums and may have different levels of urgency for the health information. Thus, age of health information and urgency may vary depending on the time that the age is measured from. This variance may be determined by the health information matching system or by the health information provider.

In another example embodiment, indicia, such as color-coding, may only change for certain interpreters on whose worklist the study resides based on the rating of the interpreter or based on a point system. The point system may factor in quality rating and dependability rating, but may additionally take into account the volume of interpretations the interpreter has performed over the course of a certain time period. Also, interpreters that have previously selected color-coded cases may be given a preference. The color code might only last for a limited time and then revert or even change for selected interpreters. For example, as explained above, the same health information may have matched to several interpreters, or may be in the same sub-set for a group of interpreters. The color code may change initially for a limited number of select interpreters. If the health information is not selected by an interpreter, the color may cascade down to interpreters with a lower point score, and then progressively to all interpreters over time. During this period, while an interpreter may not know the exact bonus he would receive, either in terms of price, rating, or points, the interpreter would understand based on the indicia that he would receive some premium above the minimum and would be awarded points for taking these cases.

The time function may also vary based on a system variable. For example, the speed at which a health information ages may vary as a function of the number of interpreters currently logged in the health information matching system. If there are many interpreters logged on and it is likely that at least one interpreter will be able to make an interpretation, the health information is likely not to age for long. The health information matching system may determine that there is no incentive to age the health information into a second level and provide a bonus. On the other hand, if there are few interpreters logged onto a system, rather than be forced to page an on-call interpreter, the health information matching system may prematurely age the health information to a critical stage, even if the health information has not been on the system for a long temporal period of time.

After an interpreter has chosen a health information to interpret, or after the health information has been selected for the interpreter, in 3010, if the health information may be designated as for a second read, then a second read is performed in 3012, as will be explained later. However, if in 3010, the health information is on its first read, then the interpreter will read the health information, and any corresponding historical and clinical data, and distribute the interpretation of the health information back to the health information exchange system, and may also distribute the interpretation of the health information directly to a patient's doctor or the health information provider. Otherwise, the health information exchange system may aid in alerting and distributing the interpretation to the necessary parties, including the patient. For example, a patient awaiting results of the interpretation may have logged onto the system before the health information had been interpreted. If allowed by the doctor (or health information provider), the patient may have left a personal contact method, such as an e-mail, in order to be alerted when the interpretation is completed.

During the process while the interpreter is reading a health information, the health information would be held and locked and only accessible to the interpreter in his worklist unless over-ridden by a system administrator. The health information may be temporarily locked to all the other members in the health information system. If the health information is in other interpreters' worklists, in one example embodiment, though still displayed in the worklist, the health information would appear in a locked form, as shown in the example interface in FIG. 5e. In another example embodiment, once a health information has been chosen and locked by an interpreter, the health information may be removed for all other interpreter worklists. In that example case a new health information case may be added to the other interpreter's worklist. In other instances, the health information may be “grayed out” or highlighted to indicate that the case is locked.

While an interpreter has locked a health information, a timer may start. In some example embodiments, only one health information may be locked at a time, while in other example embodiments, an interpreter may lock several health information. If several health information are locked, the timer will continue running for all of the several health information even if the interpreter is not accessing the health information. The health information may be released back to the health information exchange system and unlocked upon the occurrence of a trigger event.

An example trigger event may be the lapse of a pre-determined period of time. The pre-determined period of time may be one of the send parameters, for example, if the timer has 12 hours on the clock, but the deadline designated by the health information provider is only 8 hours, the health information may be released earlier if no interpretation has been made. This example may occur if the interpreter has selected several health information to interpret but was unable to review the later health information that he has locked. In other circumstances, the system administrator may override a locked health information if an interpreter is taking too long. In one example embodiment, an interpreter will be notified by a system administrator before the lock is overridden. Such notification may, for example, take the form of an instant message or color change of a health information on the worklist. If an interpreter has locked a health information but did not complete a reading, this may negatively affect a dependability rating, as will be explained later.

Another example trigger event may be providing an interpretation to the health information exchange system. When the interpreter has completed an interpretation, the health information may be automatically unlocked and removed from the interpreter's worklist and all other worklists in the system. In some situations, an interpreter may not be able to provide an interpretation or is unclear as to what the proper interpretation should read. In such an example, the interpreter may be allowed to press an override button and indicate that an interpretation was not made. The health information would then be placed back into the system. An interpreter may also designate that a specialist may be required. In such a circumstance, the health information matching system may take the recommendation into account and calculate whether a bonus may be needed to provide an incentive. In some circumstances, a difficult to interpret health information that has been viewed and released without an interpretation may be designated as such on a worklist, as shown in the explanation of 5418 of the example interface in FIG. 5e. In another example embodiment, for all or a subset of studies, an interpreter may be precluded from using an override button and may be required to provide an interpretation. Even when such interpretation is provided, the first interpreter may for example request a second interpretation (i.e., a second opinion). If a second opinion is requested, a portion of the interpretation fee may be deducted from the first interpreter and paid to the second interpreter. Alternatively, depending on pre-authorization by the health information provider, the second interpretation may serve as a subspecialist interpretation or as a quality assurance interpretation and the health information provider may be required to pay an additional fee.

The interpretation provided by the interpreter may be a preliminary interpretation or a final interpretation. A preliminary interpretation may be a minimal interpretation necessary to make a medical decision in an emergency or non-emergency situation. The type of interpretation may be designated by the health information exchange system or the health information provider. It may be used in emergency situations. If it is used for an emergency it may be designated on the worklist display that only a preliminary interpretation is needed and the corresponding level of urgency. A preliminary interpretation may require a shortened time frame, but it may also require greater urgency. The point level of the interpretation may be calculated by the health information exchange system and properly displayed so that the interpreter is aware of the benefit to taking the particular case.

A final interpretation may be a full and complete interpretation provided by the interpreter. For example, a final radiology interpretation, may include a full clinical history, comparison with relevant prior examinations, a full description of pertinent normal findings, a full description of all abnormal findings, a differential diagnosis for each abnormal finding individually or in combination and an overall impression of all of the findings that may include recommendations for additional testing.

An interpretation may be made and transmitted and stored on the system. As explained above, transmissions and storage may be held in a database, storage servers, or other servers in the health information exchange system. Interpretations may be stored and linked to corresponding health information. Interpretations may be by voice recognition systems built into an interface; by a transcription of a recording of the voice of the interpreter; or by direct typing by the interpreter. The health information exchange system may also list potential diagnosis terms that an interpreter may choose from through an interface. An interpreter may sign each interpretation electronically. The health information exchange system may automatically create storage and audit trails and reports. The health information exchange system may provide templates to create interpretations, reports, etc.

Storage formats and audit trails may also be adaptable for health information provider preferences, laws, interpreter preferences, etc. The health information exchange system may also provide conversions between different formats. For example, an interpreter may have a preferred template that does not conform to another storage format that is required by the health information provider. The health information exchange system may automatically convert between different storage formats.

After an interpretation has been made in 3011, in 3013, the interpreter may be finished and log off the system. In 3013, if an interpreter is not finished in the system, the interpreter may re-log back into the system, or re-enter the worklist and update for a new queue of health information. At any point, the interpreter may return to 3002 and re-update some read parameters, though the system administrator may choose to block changing other read parameters, such as minimum price.

If in 3010, the health information picked was for a second read, in 3012, the interpreter (different than the interpreter in 3008), if qualified, may perform a second read. The health information system may have filtered out the health information so that it may only appear in worklists of qualified interpreters. If however, the interpreter is not qualified to be a second reader, the interpreter may return the health information without penalty. The process of performing a second read, or a double read, may be described in more detail in FIG. 3f.

Health information may also be suggested for needing a second read by interpreters in the health information exchange system. For example, if an interpreter is performing an interpretation, the interpreter may search through a database of the health information exchange system for references or prior health information and interpretations for comparison. If, upon review, the interpreter determines that there is a discrepancy (e.g., a missed finding) in the prior interpretation, the interpreter may mark the interpretation as having a potential missed finding and rate the severity of the miss. The health information exchange system may evaluate the indication of the miss and may put the health information and the corresponding interpretation through a second read (or not put the study through a second read).

The qualification of the interpreter to perform a second read may depend on the credentialing of the interpreter. In some example embodiments, any interpreter of an equal level (or in some instances a lower level) to the interpreter of a first read may be a second reader for the same health information. In instances where the second reader is of lower qualification, the temporal second interpretation may still be compared to the temporal first interpretation to provide quality assurance, using the temporal first interpretation as the standard. In other example embodiments, only interpreters of a higher level may provide second reads of the same health information. The core group of interpreters may also perform second reads. Interpreters in the system, as explained above, may be one of many types of background, such as doctors, or more specifically a radiologist, cardiologist, neurologist, pathologist, etc. An interpreter may also be a specialist, such as a general radiologist, or a radiologist with fellowship training.

The health information exchange system may determine the credentialing of an interpreter or a specialist using one of several methods. For example, the interpreter may provide licensing numbers/states and the health information exchange system may verify this information with third party database. The interpreters provide the state licensing information, but as explained above, interpreters need not necessarily be physically located in the same states where they are licensed. The system may allow participation by interpreters in foreign countries that may provide interpretations for images performed in foreign countries in accordance with the applicable laws of the United States and those countries. Any combination of training, licensing, and physical location may be administered by the health information exchange system. For example, an Irish-trained radiologist that received a license to practice in the United States may interpret studies from the United States even if physically located in Ireland. As another example, a U.S.-trained radiologist may receive a license to practice in Ireland and may interpret studies from Ireland, even if physically located in the United States. As another example, a radiologist trained in England may receive a license to practice in the United States and may interpret studies from India.

In another example embodiment, the credentials may be a license issued by a State government in one of the 50 States of the United States or one of its Commonwealth. The health information matching system may request verification from the government agency in charge of licensing. In another example embodiment, licensing may be issued by a foreign government, and the health information matching system may have to receive verification from the foreign group.

Some credentialing, such as a fellowship or a special training program may occur through an organizational credentialing body, such as a subspecialty board, hospital or insurer. The health information exchange system may request verification from the credentialing body. For example, the health information exchange system may verify that the interpreter completed fellowship training in a subspecialty area or that the interpreter completed training or performed research in a subspecialty area for an academic department, such as at a teaching hospital. In other example embodiments, the health information matching exchange system would automatically receive lists of graduates of fellowships, special training programs, or other example post-graduate training programs that may be eligible to become members in the health information exchange system. This information may be stored in advance so that extra querying would not have to be performed to verify credentialing.

An interpreter may have received credentialing from a third party organization within the interpreter's field. The health information exchange system may query the third party database for such credentialing verification. For example, a radiologist, or other doctor, may be credentialed through the American Board of Radiology (or other body recognized by the American Board of Medical Specialties and the American Medical Association) or an equivalent body in a foreign country. Another example third party credentialing organization may be a Federation of State Medical Boards (FSMB), and the health information exchange system may query the FSMB databases as well.

An example embodiment of the health information exchange system may allow an interpreter to obtain subspecialty credentialing from the health information exchange system. For example, an interpreter may request to be certified as a subspecialist, such as pediatric radiology and abdominal imaging. The health information exchange system may match the interpreter to various mentor interpreters on the system within the desired subspecialty. The mentors may act as guides and also perform second reads for the interpreter and offer feedback. The selected mentors may then decide when the interpreter has graduated from the program to become an interpreter certified as a subspecialist to read for the particular subspecialty. Such certification will be distinguished from subspecialty certification granted by the American Board of Radiology.

To become a mentor the health information exchange system may deem that the interpreter subspecialist have a minimal quality and dependability rating, or possibly even a minimum number of reads in the health information exchange system. In return, qualified mentors may be paid a certain sum of money in addition to the additional fee received for performing each second read. The number of mentors and length of the training programs may vary depending on the type of subspecialty.

Another example embodiment may allow interpreters to become subspecialist by performing a fixed number of interpretations for that subspecialty and receiving a certain quality rating from second read interpreters. Or, the health information exchange system may require a minimum fixed number of interpretations and an overall threshold quality rating for all interpretations. Over time, the interpreter may be able to accumulate enough positive quality ratings to overcome the threshold. The interpreters performing the second reads may be those in the particular subspecialty or possibly from the core group of interpreters. Interpreters desiring to become subspecialists may be required to pay for the certification process.

After a second read has been performed in 3012, a determination is made in 3013 if the process is finished. If in 3005, if there had been no interpreters online, or if in 3007, no matches could be made between a health information provider and interpreters on the system, then in 3014, the health information exchange system may search the list to see if a trigger has occurred.

A trigger may be an event or a counter that may indicate that there is no match or that there is a problem in the system that may require the assistance of an interpreter that is not in the main list of searchable interpreters. The trigger event may be for a grouping of health information or for a single health information that is not matched. In 3014, if a health information may not be matched or if there are not enough interpreters online for a health information, it may first be filtered out if the health information is for a second read. Second reads may be filtered out because a second read to evaluate or provide quality assurance may not require the urgency of paging an on-call interpreter. A system administrator or the health information exchange system may override and allow a second read, if, for example, an urgent second read is required if an emergency preliminary interpretation was made but required a specialist interpreter to confirm.

A trigger event may be one of several events, for example, if a critical time window or time frame for a health information was past, then an on-call interpreter may be contacted. This may occur if a health information lingered on several interpreters' worklists and was never chosen. This may also occur if an interpreter chose the health information, allowed it to linger, and it was taken away from the interpreter because there would be no time left for the delinquent interpreter to provide an interpretation, particularly if the interpreter had locked down several other health information in his worklist.

Another trigger event, if coming from 3005, is that there may not be enough interpreters in the system, for example, the health information exchange system may set that a threshold minimum number of interpreters and/or specialist interpreters are in the health information exchange system. The minimum threshold may be a function of the number of health information and estimated time that would be needed to complete interpretations.

A special event trigger may be a trigger designated by the health information provider. For example, the health information provider may make a special request that the health information matching system recognizes that the current interpreters on the system would not be able to handle. Thus the health information matching system would automatically trigger a contact for an on-call interpreter.

In 3015, if any of the example trigger events occurred, in 3016, an on-call interpreter may be notified, as explained in more detail in FIG. 3g. In 3017, the on-call interpreter, or core interpreter if needed, may interpret and distribute the health information, similar to an interpretation made in 3011. In 3013, the review of health information is completed, with the interpretation made.

If in 3015, a trigger event did not occur, in 3018, the health information exchange system may determine if the health information can be interpreted in the system. The health information exchange system may request additional send parameters from the health information provider, request additional data, such as historical information, or request improved images using an improved equipment rating. If a retry is available, the health information and any additional data is placed back into the system and the process returns to 3005. If in 3018, a retry is not available, the health information may be submitted to a system administrator in 3019. The system administrator may evaluate the health information, possibly with the advice of a core interpreter or with the feedback of the health information provider and make a final determination of whether the health information may be matched. If in 3026, the health information is interpretable, the system administrator may then assign the health information directly to an interpreter on the system, or through the on-call notification process. The system administrator may monitor the health information's progress through the system as an interpreter provides an interpretation, in 3017, and the health information follows the process in 3020 through 3025. If in 3026 the system administrator determines that the health information is not valid or cannot be provided with an interpretation, the health information may be rejected. In 3027, the health information may be returned to the health information provider citing the problems that occurred.

If in 3013, after an interpreter is finished providing an interpretation for a health information, or if an interpreter has logged off the system, the health information exchange system may update the ratings and finances of the interpreter and this may be immediately available to the interpreter or, for example, an email containing a summary or receipt may be sent to the interpreter. In 3020, the health information exchange system would tabulate the final charges for the health information, as explained in more detail in FIG. 3h. A bill may then be sent to the health information provider, or may automatically be deducted from the health information provider's account. This may depend on how the health information exchange system set up the account with the health information provider.

In 3021, the interpreter is paid their fee. This may be automatically deposited in the interpreter's account. Any taxes may be deducted and tabulated on the health information exchange system. In one example embodiment the health information provider may pay the entire fee to the health information exchange system, the health information exchange system may in turn take its fees and distribute the rest to the accounts of the various interpreters involved in a health information (e.g. with an interpretation and possibly a second read). In another example embodiment, the health information provider may be provided account information of the interpreter, and the health information provider may directly pay the interpreter and then separately pay the health information exchange system (or have the health information exchange system deduct the fee amount from an account established with the health information exchange system). In another example embodiment, the health information exchange system may have accounts set up for both the health information providers and interpreters. The health information exchange system may facilitate the transfer between accounts, but not accept payments from the accounts directly. If a health information provider does not have enough money in its accounts, or if there are complications with the transfer, the interpreter may be provided with the health information providers contact and request payment directly to the health information provider or lodge a complaint directly to the health information provider.

In 3022, health information may require redistribution. Distribution may be to the health information provider, a doctor, patient, or for a second read. In 3023, ratings affected by the health information may be attributed to the various interpreters, as explained in more detail in FIG. 3i below. The ratings may also be adjusted at the occurrence of a trigger event. For example, a trigger event may be the release of an incomplete health information. This may automatically process a rating adjustment because other processes, such as receiving payments in 3020 and paying interpreters in 3021, would not occur if the health information interpretation was incomplete.

Once a rating is adjusted, the rating may later affect the matching as explained in 3006 above and the flowchart in FIG. 3e. The new rating may penalize the interpreter by taking some of the matched health information out of the interpreter's worklist. For example, if an interpreter was just above the threshold of the minimum quality rating for a first health information, and then decreased in quality rating because of another interpretation he had previously provided for a second health information, the first health information may be removed from the interpreter's worklist. As another example, if the interpreter achieved a certain dependability rating and placed in a category to receive higher priced health information, and then failed to read several health information resulting in a lowering of the dependability rating; the interpreter may have health information removed and replaced with health information that paid at a lower rate. The adjustments to an interpreter's worklists may all be conspicuous on an interface, as explained in the example interface of FIG. 5e. The adjustments in ratings may motivate the interpreter to improve his overall ratings or specific subcategories.

In 3024, the health information exchange system may also determine a bonus paid to the interpreter. The bonus may be paid out partially by excess fees, such as the difference between a fee paid by the health information provider and the price paid to the interpreter and the total transaction fee of the health information exchange system. For each interpretation completed, the interpreter may receive additional points in a bonus score. The bonus score may also be a function of a rating associated with the interpreter. For example, to motivate interpreters to keep their quality rating high, interpreters of a certain rating or of subcategory ratings may receive additional bonus points measured at the end of a period of time. The bonus score may also be a function of the number of interpretations provided by the interpreter or a comparison of an interpreter's rate of readings compared to other interpreters on the health information exchange system. For example, bonus points may be given to interpreters that read twenty percent more than other interpreters. Bonus points may also be given to interpreters for being considered a specialist on the system. Bonus points may also be designated based on the times that an interpreter is available. For example, if an interpreter is frequently on the system at odd hours (e.g. 1 am to 6 am), the interpreter may receive bonus points.

Bonus points may also be given for participating as an on-call interpreter. The bonus points may be given as a function of the time of day of availability that the interpreter is on-call or the number of cases read while on-call or the number of total number of on-call hours or days taken.

Other bonus points may also be determined by the health information matching system. For example, if it is difficult to match a particular health information or if no interpreter on the system is picking a particular health information on the worklist, the health information matching system may particularly mark the health information with a marker or indicia to indicate that bonus points may be provided.

At the end of a period, such as a fiscal period, yearly, or in quarterly periods, bonus points may be used to determine cash payments or may be used to purchase items on the system. For example, bonus points may be used to purchase subscriptions to journals, or to pay for the option to become a specialist interpreter on the system.

In 3025, the health information exchange process may end.

FIG. 3b illustrates a flowchart of an example process of acquiring an account, according to the example embodiment of FIG. 3a. In 3100, the registration process starts, and in 3200, a participant to a health information exchange system may be presented with an interface displayed on a terminal, kiosk, PDA, etc. In 3102, a participant may be prompted to submit the type of participant, which may alter the type of data structure and memory allocated for the user in a database. However, the administrator may choose to allocate the same amount of memory for all participant types in order to allow participant types to change to other participant types later on. In 3103, depending on the methodology of allocation of memory, memory is allocated for the selected participant type. In 3119, the participant may have an optional interface to download. In some instances, access may be achieved through a typical web application, for example, through the use of an internet browser. For more complex functionality, the system may require the participant to download a software application which may provide the proper interface.

In 3104, if the participant type selected is a health information provider, in 3105, a unique account number is assigned. In 3106, the user may then be prompted to fill in information, such as information from the example Health Information Provider data structure 200 in FIG. 2. The health information provider may be able to do this manually, but since the health information provider is likely to input more information than other types of participants, the health information provider may have either a form or template with lists of preferred interpreters or health information identification numbers that may be uploaded as a group. After a health information provider completes the registration process, it proceeds to end registration by signing, or electronic signing, a tailored terms and conditions form in 3120.

If in 3103, the participant is not a health information provider, in 3107, a unique User Account Number may be assigned to the particular user. In 3108, the user may input login and contact information and other identifying information that may be in a user data structure, such as the example User data structure 202 in FIG. 2. If at this point a user is a subscriber to any journals, or is a faculty member at a hospital and school and has a bulk subscription, the user may be able to input this information to gain access to the journals that may be available on the health information exchange system. Verification may first be performed to confirm that the user does indeed have access to the journals. This sweeping category of user registration may capture much of the underlying information required for all users, e.g. interpreters, doctors, medical students, other users interested in medicine, government officials, and patients. Some special subcategories may also be recorded for further specialized forms of users.

In 3109, if the user is also an interpreter, then in 3110 the user account is also assigned an interpreter number, which others interpreters, health information providers, the health information exchange system, and others may use to rate the interpreter. Interpreter numbers allow the rating to be blinded and not allow negative bias, such as ill will to a particular interpreter or group, or positive bias, such as the presumption that a highly regarded interpreter is always correct, to influence ratings. In other example embodiments, the interpreter identity may be revealed on the interpretation, either before or just after the rating has been given. In 3111, the user will input and the registration system will receive licensing information and this information may be verified. In some example instances, the health information exchange system will have already pulled the interpreter's licensing information from third party databases or public databases and would only require the interpreter to confirm the information. In other example instances, an interpreter may input specific account numbers for the states or list the states and the system may verify the interpreter's licensing information. For special types of verification regarding an interpreter specialty, the interpreter may either list this information to be verified, or the health information exchange system may also allow the interpreter to participate in its internal credentialing program, which will be explained later.

In 3112, the interpreter may establish financial accounts, such as credit card accounts, bank accounts, online monetary accounts, etc. This financial information may be later used by the health information exchange system to pay the interpreter for interpretations received, or to deduct charges for medical articles purchased, subscriptions to medical journals purchased, or attendance to continuing medical education or conferences purchased through the system. As explained above in 3021 of FIG. 3a, the health information exchange system may provide a method to facilitate the transfer of funds from health information providers to interpreters, set up accounts for a health information provider to access, or to set up mechanisms that allow the health information exchange system to indicate to the health information provider accounts to directly transmit funds to an interpreter. In an example embodiment, bank information may be collected from the provider and the interpreter. In another example embodiment, accounts may be established within the health information exchange system, and health information providers may directly deposit funds into the accounts.

In 3113, the interpreter may indicate whether he or she has interest to be an on-call interpreter. The interpreter may select the general days of availability, times of availability, specific holidays, and specific dates during the year. The interpreter may also indicate the premium that the interpreter would like to be paid to be contacted while on-call. The system may pay the interpreter an amount to be on-call in addition to the premium for each time the interpreter is contacted while on-call. However, the amount to be on-call may be deducted if the interpreter's dependability rating is low, dips below a certain threshold, if the interpreter is not available when contacted, if the quality rating is low, or any of a number of other terms and conditions that are violated. The system administrator may determine that the on-call interpreter is only allowed to alter the on-call periods a few times through a year, as many times as desired, or only when prompted to do so. This flexibility will depend on the load of the health information matching system, meaning the number of interpreters available to be matched, those currently online, and the number of health information data on the system or expected to be on the system.

In 3114, the interpreter may indicate whether the interpreter is a core interpreter. The core interpreter may be another form of interpreter that may also be an on-call interpreter. The core interpreter may have an invitation from the health information exchange system which may allow the interpreter to be classified as a core interpreter. The core interpreter, on registration, would input either the invitation code, or the system would have already recognized the interpreter as an invited core interpreter and ask the interpreter whether or not he or she would accept this designation. The core interpreter, in addition to optionally being an on-call interpreter, is an interpreter that is available when all the on-call interpreters are not available. This may occur for any number of reasons, for example, if the system is overloaded and all the on-call interpreters have been called and are busy, or if there are no on-call interpreters signed up for a specific period, etc. The core interpreters may be paid a set fee to be a core interpreter and may also receive an additional premium on top of a potential on-call premium to be available or may receive stock options (or their equivalent) or a guaranteed base salary.

In 3115, the interpreter may input any other miscellaneous information. Some of this information may be other information listed in the data structure for interpreters 203 in FIG. 2, such as a list of health information reviewed. The interpreter may input the interpreter's own list of patient histories as a record for other interpreters to pull from to increase the knowledge base in the system. Once the interpreter has input all the available information, it proceeds to a tailored terms and conditions form and ends the registration process in 3120.

If in 3109, the user is not an interpreter, if in 3116, if the user is a patient, the user may have temporary access to his own records. In 3117, the patient may enter a code that he or she may have received from the doctor to provide temporary access to the health information exchange system. The patient may have limited temporal access as well as display access. The patient may have to download an interface, but it is likely that the system administrator may allow access through a simple web application interface. In 3118, the patient may input personal identification information. This may be used to finally verify the patient's account and also provide an added layer of security. The health information exchange system may obtain patient waivers to allow access to their prior information from other third party servers. The waiver may be obtained by the health information provider on behalf of the patient or user without having to involve the patient directly. For example, in compliance with HIPAA, a doctor may consult with another doctor regarding a patient, and the patient's doctor may be permitted to do this without patient consent.

For recurring patients, patients that are frequently in the health information exchange system, the doctor may provide an input code that allows a patient to have longer access. If the doctor is a user in the system, the patient account may also be directly linked to the interpreter's account, such that updates to the patient's information, e.g. if the patient sees another doctor or has to go to the emergency room and undergoes a radiology test, the patient's primary care doctor may be immediately informed of the patient's status. The patient may also designate another physician to have temporary access to his or her health information. For example, if a patient goes to the emergency room or sees another physician, the patient may allow the physician to see a summary of the stored health information, interpretations, clinical information, and other data related to the patient in the system.

FIG. 3c illustrates a flowchart of an example process of receiving and adjusting of preferences, according to the example embodiment of FIG. 3a. In 3200, the receipt and adjustment of preferences starts. In 3201, a health information provider may set the health information case descriptors, meaning information about the health information. For example, the modality, the body part, the study description, prior exams, clinical information, reason for the examination, pathology information, referring physician, contact information for the referring physician, patient identification information, a portion of the patient medical record such as chart entries, time urgency, the total number of images, the equipment type used to create any part of the health information, etc.

In 3202, the health information provider may be shown a suggested minimum price. This may be as a result of the prior health information descriptors or any send parameters and the price may be fixed based on one or more of the input of health information descriptors and may be determined in a dynamic interactive format. The particular descriptors and send parameters may require a higher price or may allow for a lower price.

In 3203, if the health information provider may allow for an extra bonus to be paid, in 3204, the health information provider may set the bonus. The bonus may serve the purpose of allowing the health information provider to initially set a maximum price below the suggested maximum price with the hope that an interpreter may enter the system that may accept a lower price than those interpreters that are currently on the system when the health information is being added to the system. If the health information lingers on the system, the bonus may be the increase of the price over time. As the health information ages, the price may increase as a function of send parameters, as a linear function, exponential, or any of a number of factors that may be set by the health information provider or, under a contractual or other agreement, set by an administrator of the health information exchange system. The health information matching system may also provide suggestions on how to increase the price over time or alter the send parameters in order to maximize the chance of the health information to appear and be read on an interpreter's worklist. A bonus may also be for different levels of send parameters. For example, a health information provider may provide a bonus for a subspecialist, an interpreter rated at a higher quality, or other send parameters, etc.

If in 3203, the health information provider does not want to allow bonuses, then the health information matching system, may make a determination based on the health information case descriptors and the send parameters that the health information provider specified unreasonable criteria such that no interpreter on the system would have read parameters that would match. In other words, the health information may never appear in any interpreter's worklists, or because the health information provider has set a maximum price too low. In such an example, the health information matching system, may automatically readjust the price of the health information provider, or reject the health information from the system. The health information provider may then accept or reject the change of the health information matching system. In one example embodiment, there may be a contractual or other agreement whereby the health information matching system may automatically adjust parameters to assure that the study will appear on at least a minimum number of interpreters' worklists.

In 3206, the health information matching system may sum the final price, display this information to the health information provider, and set this information to the health information case. If the health information provider had allowed bonuses, different levels or alternatives of prices may be shown. Moreover, the health information matching system, would show the increase of the price change over time, up to the maximum reasonable price allowed. In 3207, the receipt and adjustment of preferences would end. In this example flowchart, the health information matching system may provide variable prices and allow the health information provider to vary and change its price.

In another example flowchart, the health information matching system may allow a health information provider to only choose fixed prices. For example, in 3201, after setting the health information descriptors, the health information matching system may show a fixed price in 3202 for the health information and its various characteristics. If the health information provider wanted to allow an extra bonus in 3203, the health information matching system would provide fixed prices for each characteristic. For example, a health information provider may expect to pay an extra dollar per increase in quality rating, an extra fifty cents per decrease per hour in the time period to read, an extra five dollars per subspecialty required, etc. Fixed amounts may be based on local Medicare reimbursements and may be updated automatically when changes occur. The differential prices may be displayed using drop-down menus that automatically adjust the price after selection of each option.

If in 3203, the health information provider does not allow bonuses, in 3205, the only adjustment of preferences would be the basic price if the number of interpreters changes on the system. Though the price of the health information interpretation is fixed, in this example not varied by the change in the send parameters by the health information provider, it may vary by the control of the health information matching system. For example, the health information matching system in 3202 may provide a suggested range of prices which may reflect the estimated troughs and peaks of the number of interpreters expected on the system and automatically take into the account the possible need to contact an on-call or core interpreter. The health information matching system may describe and set the increment in price as the health information ages in the system, helping to minimize the cost per reading over a period of time. The health information matching system may also offer alternatives, such as minimizing the amount of time though at a higher price, or maximizing the amount of readings per period of time, rather than just minimizing price. The health information matching system may use historical data to determine this information, and if there is no historical data it will offer estimates as a function of normal prices offered in the market and/or the read parameters of interpreters on the system. In 3206, the final price ranges would be set for the health information and in 3207 the preference adjustments would end.

FIG. 3d illustrates a flowchart of an example process to receive health information, according to the example embodiment of FIG. 3a. In 3300, the health information exchange system commences the receipt of health information. The receipt of health information may be continuously occurring while matching and interpreting is being performed.

In 3301, the health information exchange system receives health information. The health information may be in one of many numerous formats. A conversion process may be required to convert from each health information providers' format to a standard format for the health information exchange system. In another example, the health information exchange system may have a set standard and indexing system to which health information providers may conform their health information. For example, a format that may be used is the Digital Imaging and Communications in Medicine (DICOM) standard. The health information may be stored inside a storage device which may be inside a firewall connected through a communication medium, such as the internet. The storage of the health information may be distributed across various storage devices to spread the load on the system. The storage of the health information may also be in a separate storage device (e.g., a server) from the storage device that receives the health information. Processing may occur in only one, or across several of the storage devices, depending on the storage configuration determined by the system administrator.

In 3302, after the receipt of the health information, any health information descriptors that were not pre-input by the health information provider would be parsed from the health information data. In 3303, the parsed information may be matched with the information provided previously by the health information provider. If there is no match, then the health information is designated for a re-check in 3304 and the health information receipt process is completed in 3305 temporarily for the health information to be correctly re-processed in 3004 of FIG. 3a.

If in 3303, the health information provided matches the descriptors provided by the health information provider, in 3306 the health information exchange system may determine historical information and add information. For example, the health information exchange system may try to determine if the particular patient associated with the health information has been through the health information exchange system before. If so, the health information exchange system may, depending on the condition, link previous health information, such as clinical information, pathology results, or prior related health information such as prior radiology tests, to the newly added health information to provide an interpreter with a complete picture of the patient's status. The health information exchange system may also allow an on-site technologist, i.e., a technologist at the site of the health information provider, to add additional patient data into a comment field that may then become a part of the health information data. The health information provider that provided the health information may also be queried for additional information relating to the health information that may be queried and extracted from the health information provider's internal servers or other storage devices.

In 3307, if there are other health information providers that have not been queried, in 3308, those health information providers may be queried for older health information regarding the patient associated with the newly added health information. The alternative health information providers may be those associated with the health information exchange system. Other medical servers may also be queried. These medical servers may be hospitals or systems related to health information providers that are a part of the system, but they may also be medical servers that share information with the health information exchange system. The medical servers may be associated with hospitals, individual doctors, individual organizations, that have a relationship with the health information exchange system in order to provide comprehensive care for a patient.

In 3309, the older historical studies or health information relating to the patient may be received from medical servers and this information is stored in the health information exchange servers and linked to the first newly added health information. When all of the health information providers and medical servers that are willing to share information have been queried, the information is gathered and linked to the new health information. Some medical servers may also participate in the sharing network but only if they reserve the right to store the information. In such an instance, the health information is designated as temporarily stored in the health information exchange system until an interpreter has completed reading and provided an interpretation. After the interpretation is provided to the health information exchange system, all data designated as temporary may be deleted.

Medical servers, hospital networks, and health information providers may want to share prior studies, imaging studies, and other health information to the health information exchange system in order to promote patient health. However, 3007 to 3009 may be avoided if those systems allowed information to be stored with the health information exchange system permanently, such that the querying is internal. This could save those medical systems storage space and increase the efficiency of transmitting health information and also to aid in linking all of a patient's health information together from various medical systems. The medical servers may choose to transmit health information on a daily, weekly, monthly, etc. basis, and participating medical servers may be designated as part of the health information exchange system's network. Patients may then prefer to go to health information providers, such as imaging centers, that are within the information sharing network of the health information exchange system.

Third parties may also be able to query the system for health information. An example configuration of the system may be to allow medical servers within the information sharing network to access information for free, while other medical systems that did not willingly share information would still be allowed to query for a fee, either as a subscription, on a per query basis, etc. The health information exchange system, in compliance with security and privacy laws, may also verify the proper credentials of the third party. The query may also require a proper patient authorization in order to protect the privacy of the patient. The query may allow authorized users to query for old health information, interpretations, articles, etc.

In 3310, the health information exchange system may remove patient identification information from the health information data. The information, though removed and blinded to the interpreter, may still be linked to the health information data. The information may be stored in case the information is needed to verify a patient or to comply with federal or other applicable law. For example, when the patient logs onto the system it may provide a patient name, address, social security number, birth date, or other personal information to verify that the patient is accessing the information. The removed personal information may be placed in the same server. If the system administrator chooses, the patient identification information may also place the patient information in a separate server for greater security. The information may be behind a second firewall layer and may require an encryption key separate from the encryption already used for the health information. The added level of security may ensure legal and ethical compliance with the protection of patient identity and protection of private health information.

In 3311, the health information and all related historical data may be stored. Health information may be medical images, image data, historical health information of the patient, clinical data, an imaging test, a radiology image, a pathology image, pathology data, etc. Health information may be stored into separate servers or database fields based on the health information type. In other configuration, the health information may be stored in relation to the unique health information number, such as that of data structure 201 of FIG. 2. The health information may be optionally encrypted. In 3305, the receipt of health information process is completed.

FIG. 3e illustrates a flowchart of an example process of administering matches between health information and interpreters, according to the example embodiment of FIG. 3a. Health information may be filtered first by send parameters and then by read parameters. Worklists of interpreters should not be crowded with a large number of health information. The health information matching system may try to balance the load of each worklist. For example, one health information case may appear in forty interpreters' lists, and the number of interpreters may be based on the total number of interpreters in the system or the total number of interpreters that are capable of interpreting that health information. The balance that the health information matching system may achieve is to list all cases on all interpreters' worklists if there are few interpreters online and decrease the number of cases on each worklist as the number of interpreters online increases to the opposite point where there are an extremely large quantity of interpreters but few cases to be interpreted. When health information numbers reach this latter point, the interpreters may be further distinguished by other factors, such as quality rating, etc. as will be explained.

In 3400, when there is health information and interpreters on the system, the health information matching system may commence matching. In 3401, health information data or grouping of health information data is placed into a temporary distribution array and in 3402 is arranged in the array by level of urgency. A group of health information may be health information that has the same descriptors, the same send parameters, or may have been grouped together by the health information provider because they were transmitted together as a group to have the same characteristics, or the health information matching may have grouped health information together in the system because they have similar urgency requirements. Urgency requirements may be a price range or a time frame. Other urgency requirements may be to divide health information into routine and emergency, and these may in turn be divided into day, evening and overnight. In this way, interpreters on the system will receive the most urgent information first so that urgent interpretations may exit the system faster. After processing, in 3402, the distribution array will be in a first in first out (FIFO) queue by order of urgency.

In 3403, for each health information provider, a temporary distribution list may be created for the health information provider that will hold links to or interpreter identification numbers for the each health information data or grouping. In 3404, the list of health information for the health information provider is traversed and the list of interpreters that are currently online may be traversed and filtered out by the send parameters of the health information provider.

The order of importance of filtering may be chosen by the system administrator. For example, if there are few interpreters on the health information exchange system, the system administrator may choose to use a limited number of send parameters. Or, as another example, if there are few interpreters online or few on-call interpreters, the system administrator may try to open up the list of available health information to as many interpreters as possible, limiting the use of filtering by send parameters.

One example method of ranking the send parameters is to first filter by state of license. This may be chosen as the first level of filtering because in some jurisdictions the interpreter who is not licensed in that jurisdiction may be precluded from providing an interpretation by law. The next level of filtering may be by modality or body part. It is not possible to alter the modality or body part of a health information, and if it is important for an interpreter to be listed or if the interpreter is not qualified to read, then it may be important to be filtered out earlier.

The next send parameter to filter out is the maximum, minimum, and range of prices. As explained above, there may be many methods by which to calculate the price, either fixed or varied. The price may also be incremented over time. The health information matching system would ideally try to maximize the price paid to the interpreter, the fee paid to the health information exchange system, and minimize the cost to the health information provider. There may be many ways to determine the price ranges that are filtered that factor in the fee and other variables.

For example, the health information matching system also may provide incentives to interpreters to keep their quality and dependability ratings higher by placing higher paying health information data in the worklists of those interpreters with higher ratings. One equation to determine a price filter is:

Rating filter value=Send price−minimum price−fee−Fcn(x)

The Rating filter value takes the Send price into account. Send price may be one of the various send parameter prices on the range of allowable prices, such as the maximum price allowed. Minimum price may be the read parameter minimum price for each interpreter, an average minimum price on the system, or the minimum price in the send parameter range. Fee may be the fixed fee that is taken by the health information exchange system for each interpretation provided, or it may be a variable fee, such as a percentage of the difference between the cost to the provider and price paid to the interpreter. Fcn(x) may be a function that determines a reduction or addition of the score based on x, which may be a quality rating, dependability rating, or an on-call rating, or a combination thereof that takes all the ratings into account.

Another example price filter may be:

General filter value=Send price−minimum price−fee

In the above example, the general filter value may be a base price filter that doesn't take other send parameters into account. Send price, minimum price, and fee may be similar to the variables above.

Another example filter may be a clinical data rating price, wherein the Fcn(x) above is a function of x, which may have a factor in the clinical data rating. If there is more clinical data or historical information attached to a particular health information, it may take longer to read the study. On the other hand, if there is more data, it may make the reading easier to perform because less speculation is needed and the quality rating of the interpreter may increase. These judgments may differ for individual interpreters and could be a read parameter. These types of factors may be taken into account when the health information matching system is determining the clinical data rating.

The next send parameter may be any of the time-related send parameters, such as the time frame needed to read the study. Other send parameters may be filtered out, such as requesting a specific interpreter, group, or interpreters with a specific subspecialty, etc. As new types of send parameters are added, they may also be used to filter out the health information.

When the health information matching system has filtered out all the health interpreters for a health information using the send parameters, in 3405, it is determined whether there are any interpreters left online that may read the health information. If there are interpreters that have not been filtered out then the health information may be filtered by the interpreters.

It may be appreciated that in a system with a significantly large amount of health information and interpreters, the filtered down list may still be excessively large. So as not to overwhelm the interpreters, each interpreter may not receive the entire list of possible health information to filter. Optionally, in 3406, the interpreter may receive a subset of health information. The subset may be by random selection so as to evenly distribute the multitude of health information among the interpreters that may view them. Another example method of creating subsets is to subdivide the most desirable health information by price and equipment rating and also to subdivide interpreters by quality rating and dependability rating. The highest rated interpreters may receive the most desirable subsets of health information, e.g. those that pay the highest and were created with the highest equipment rating. If there are still too many health information data in these subsets, the information may then be randomly distributed among the various corresponding lists, e.g. best subset to best rated interpreters, medium level subsets to medium rated interpreters, etc.

In 3407, the health information matching system takes the list of possible health information that was filtered to the interpreter and further reduces the list by the interpreter's read parameters. Like the send parameters, the order of importance or filtering may be determined by the health information matching system, overridden by the system administrator, or possibly the interpreter may rank the importance of the read parameters. For example, a predominant factor in filtering is the time that the health information interpreter has available to perform an interpretation. A filter may be done on read parameters, such as the time of reading, number to read, time period to read a study, or time period per case. The minimum read price may again be taken into account and possibly any preferred health information providers.

When the interpreters have filtered out by read parameter the sub-list of health information that they are willing to see, then those health information are considered a proper match between the send parameters and read parameters because that health information would have made it through at least both filtering processes.

In 3408, if the final number of health information remaining in the list is greater than a number, pre-determined by the health information matching system that is derived by maximizing the number of health information in interpreters' lists, the worklist may be designated as full for that online interpreter. As the interpreter finishes reading health information, more health information may be added as more health information is added to the system, or may be taken from other interpreters' lists when those interpreters sign off the system. The matching ends in 3409.

If in 3408, the remaining health information in the list was below a threshold number for a worklist, the process of filtering may be repeated in 3406 and 3407 so that the interpreter may be given the choice to see health information that he otherwise would have filtered out, but may still be willing to read if given no other choice. For example, some health information may have a lower than desired equipment rating, but the interpreter, with no other health information in the worklist, may decide to read the health information in order to make some money. In some instances, for each level of filtering, the list may be stored such that an interpreter may easily decide not to filter by a certain read parameter and the list would automatically repopulate quickly the unfiltered health information worklist before it had been filtered. As another example, though an interpreter may be licensed in several states, such as New York, Massachusetts, and Rhode Island, the interpreter may have only chosen to read health information requiring an interpreter to have a New York license. If the interpreter wanted to expand the worklist, the interpreter may expand the parameters to allow health information requiring interpreters with licenses from Massachusetts. The health information matching system may then re-populate the worklist with the health information.

If in 3405, there were health information that could not be placed in any interpreter's worklist, the health information may be designated as having been filtered once and may be returned to be re-filtered. In the second time around in 3404, the health information matching system, upon noticing the designation as having been filtered once, may check to determine if bonuses are allowed or if there are more minor send parameters that may be excluded. It may keep reducing send parameters until a minimum number of interpreters are not filtered out. It may be designated as a rejected health information with unreasonable send parameters, or it may simply be designated as having no available match and may be placed in a list to be reviewed by an on-call interpreter or core interpreter to make the final call.

FIG. 3f illustrates a flowchart of an example process of performing second reads, according to the example embodiment of FIG. 3a. Performing second reads, or double reads, as explained above, may be for the purpose of credentialing doctors as subspecialists, for quality assurance or for some other purpose. The second read process may be independent of the general health information matching to interpreters to receive interpretations when used for the credentialing process. However, the second read process may also be integrated with the process, as shown in FIG. 3a, when used to perform quality assurance and determine the integrity of the interpretations that are occurring on the health information exchange system. The system administrators may designate health information for second reads, for example, in order to randomly check the quality of its interpreters in order to provide them with a quality rating. Health information providers may also want to assess their own interpreters or the interpretations they are receiving for their health information, and may designate some of their health information for second reads.

For the purpose of clarity, the first interpreter may refer to the interpreter that provided the first interpretation of the health information, which may be the original interpretation. The second interpreter may refer to the interpreter that provides the second interpretation of the health information. A third interpreter may also provide a third interpretation as will be explained below. In other example embodiments, as discussed above, a first interpreter may be a higher quality interpreter and the second interpreter may be a lower quality interpreter. In such a quality assurance scenario, the first temporal interpretation may be regarded as the standard against the second temporal interpretation. The health information exchange system may then compare the two interpretations and make an evaluation, a third interpreter may make an evaluation, or the first temporal interpreter may evaluate the second temporal interpretation.

In 3500, a second read may be initiated. In 3501, an interpreter may be picked to perform a second read. The interpreter may be determined by the matching method as described in 3006 in FIG. 3a or from FIG. 3e. For example, the first parameter to filter would be interpreters of only the subspecialty required for the health information, or for interpreters of a specific minimum threshold quality rating. Or, the health information exchange system may designate certain interpreters to be second readers, and the interpreters would be directed to perform the second reads in their worklists. The interpreter may also be determined according to a credentialing process, for example, a mentor may be pre-designated to perform the second read. After the interpreter is determined, in 3502, the interpreter is provided with the health information either automatically or in the worklist.

In 3503, if the first health information was only a preliminary interpretation, in 3504, the second read may instead be a full interpretation, in addition for the purpose of evaluating the first interpretation. Since, the second interpreter will have performed a full evaluation, the first and second interpretation would be compared in 3507, as will be explained below. In other example embodiments, a preliminary interpretation may not require full second read. For example, if the health information provider did not want to pay the higher price and the preliminary interpretation sufficed, the second read may commence similarly as if either a full or final interpretation had been performed.

In 3503, if a preliminary interpretation had not been performed, rather if there had been either a full or final interpretation, in 3505, the health information exchange system would determine whether there would be a need for a blind read or not. A blind read may be a second read method that allows a second interpreter to first perform an interpretation without being biased by the first interpretation. For example, in 3506, the second interpreter first performs a second interpretation. In 3507, the first and second interpretations may be compared. The comparison may be performed by the second interpreter, the first interpreter, a core interpreter, or by the health information exchange system by comparing text, etc. It is then determined whether a threshold of discrepancies is exceeded in 3509, as will be explained below.

In 3505, if the health information was not designated for a blind second read, in 3508, the second interpreter may be provided the first interpretation of the health information. The second interpreter may optionally provide a second read by following 3508 and completing a second interpretation as in 3506. In other example embodiments, the second interpreter would follow 3508 and would be able to make a second read evaluation using the first interpretation and the health information provided. In 3509, it is then determined whether a threshold of discrepancies is exceeded. One example method may determine a threshold by counting the number of discrepancies. The discrepancies may also be weighted by importance. For example, not diagnosing a cancer would count as a major discrepancy, but not diagnosing an adrenal adenoma or hepatic cyst, for example, would be considered a minor discrepancy. In another example, the first and second interpreter may come to the same diagnosis but may disagree on the location of one or more abnormalities associated with the diagnosis. This may also be designated as a discrepancy that crosses the threshold. The health information exchange system may designate the threshold number of disagreements or discrepancies, and this may vary depending on what the basic diagnosis was from the first interpretation.

If in 3509, the threshold for discrepancies is breached, in 3510, the health information exchange system may process discrepancy alternatives. For example in one example alternative, the more qualified interpreter would be able to view the other interpreter's results and decide which report should be sent as the final report (or create a new report which merges the findings). In another example alternative, the discrepancy history, health information, first interpretation, and second interpretation, if available, may be provided to the third interpreter who may act as an adjudicator interpreter. The third interpreter may review the two previous interpretations and choose which of the two reports is correct (or create an entirely new report if he determines neither is correct). In another example alternative, the divergent interpretations may be sent on to the referring health information provider, wherein the second interpretation is simply viewed as a differing second opinion. The health information provider may request that a third interpreter provide an adjudication, as explained earlier, or the health information may decide not to continue with the second read process. Prior to the initiation of the second read, the health information exchange system or the health information provider may pre-set which of any number of alternatives to apply if there are divergent interpretations. However, the decision to apply an alternative may be decided at the time of the actual determination is made that the interpretations are divergent. For example, if the system is under a heavy load and there are not enough resources to have a third interpreter review the interpretations, the health information exchange system may proceed to provide both interpretations to the referring health information provider with the primary and second opinion and allow the health information provider to determine the action to take. If, for example the system is under a heavy load, the health information provider may insist on having a referee adjudicator, and the health information may either have lower priority, or may require extra bonuses to be associated with the health information.

In another example embodiment, the third interpreter may also provide a full interpretation, and this interpretation may be blinded as well. In 3511, the third interpreter may rate the first interpretation. The third interpreter may also rate the second interpretation and second interpreter if the second interpreter was considered wrong.

In 3509, if the discrepancy threshold is not breached, in 3511, the second interpreter may rate the first interpretation. In 3512, the second and third interpreter may rate the first interpreter, and this may either affect the quality rating, or it may affect the credentialing rating if that is the purpose of the second read. The rating may be a function of the comparison of the first interpretation and second interpretation. The rating may also be an objective evaluation of the first interpreter's methodology by the second and third interpreter. The rating may additionally be provided by a health information provider or the health information matching system after the discrepancy in the comparison of the interpretations has been evaluated.

In 3513, the second read process is completed. The second read process may also involve a second read, wherein the first interpreter is verifying that the interpretation is correct given the historical information provided. For example, if the historical health information designates the patient associated with the health information to have colon cancer, that the interpretation of the first interpreter would confirm that the historical information and diagnosis are correct.

FIG. 3g illustrates a flowchart of an example process of notifying an on-call interpreter, according to the example embodiment of FIG. 3a. The on-call notification process starts in 3600. In 3601, the trigger that required an on-call notification may be confirmed. An example confirmation may be a sweep of the list of interpreters to determine if any new interpreters have signed onto the system that may be able to fill the request. Another example confirmation may check the financial records of the health information provider to determine if the on-call request is in the budget. For example, some health information providers may allow bonuses, but may allocate a fixed budget for any bonus money and require an accounting before a new budget is allocated for use of the bonus funds.

In 3602, an on-call interpreter is requested. The on-call interpreter may be contacted through one of the contact means designated by the interpreter. This may be on a pager, an automated message over the phone, a voicemail, an e-mail, text message to a personal wireless device, etc. The on-call interpreter may have a set period of time that he is required to sign onto the system or to indicate through a communication medium that he is on his way to sign into the system or will be unable to sign on. In 3603, if the on-call interpreter indicated that he is available, the notification process ends in 3610.

In 3603, if the on-call interpreter is not available, in 3604, the on-call interpreter's rating may drop. The dependability rating may drop, and if there is a separate on-call rating may also be decreased or there may be some other penalty, such as a financial penalty. The change of the rating may not be fixed. The health information exchange system may determine the level of change in the rating, and this rating may also be appealed to the system administrator.

In 3605, if the on-call interpreter's negative rating surpasses a threshold trigger, in 3606, the on-call interpreter may be removed from the on-call interpreter list and may not receive any more contacts as an on-call interpreter, and there may be an additional penalty, such as a financial penalty. If in 3605, the trigger point has not been reached, the on-call interpreter may be warned that his rating has been decreased. If the interpreter has been removed or warned, the health information exchange system may also provide ways in which the on-call interpreter may again become an on-call interpreter or to increase his on-call or dependability rating.

Since the on-call interpreter was not available in 3603, in 3608, the health information exchange system may go to a third line of back-up interpreters, the core interpreters. In order to determine if a core interpreter may be requested, in 3608, the health information exchange system may determine if a core interpreter trigger event has occurred. A core interpreter, as explained above, may be an additional level of back-up. These interpreters may be an assortment of interpreters and many may also have sub-specialties. Some of the core interpreters may also serve as floating system administrator and may be called upon to perform second or third reads, override locked health information, or provide assistance to the general group of interpreters on the health information exchange system.

An example trigger event may be a critical time window associated with the health information, similar to a trigger event for the on-call interpreter. In the example scenario, if a health information has aged to the point where interpreters on the system cannot be matched to it or interpreters have not chosen the health information on their worklists and the on-call interpreters are also unavailable, the core subgroup of interpreters may be needed so that a health information is not left unread on the system. Otherwise, if a core trigger has not occurred, the health information exchange system may continue to request on-call interpreters in 3602.

Another example trigger event may be a request for one of the core interpreters by a health information provider, an on-call interpreter, or one of the interpreters in the health information exchange system. This may occur because the core group of interpreters may be generally known to the participants in the system, and there may be a specific need for one of their specialties. Furthermore, the core group of interpreters may also be specialized interpreters and may typically provide the tie-breaking or definitive interpretation. If a health information needed urgent interpretation, having a core interpreter immediately read the health information may decrease the time it spends lingering in worklists.

Because many of the core group of interpreters may be specialists, another example trigger may be if the health information exchange system detects that a minimum threshold of specialist interpreters required on the system would not be capable of reading for the health information that would require specialists. This may also be a trigger event for the on-call interpreters, but core interpreters may be put on notice in case the on-call interpreters are overwhelmed by the number of requests. Similarly, another example trigger may be if during a certain period of time the number of on-call interpreters available to be contacted is below a minimum threshold. The core interpreters may also be contacted to be ready to serve as a backup. Core interpreters may also have a special event trigger, and this special event trigger may be an emergency trigger as requested by the core interpreters, the health information providers, or the health information exchange system (e.g. the system administrator or from the various programs on the servers).

If in 3608, a trigger event to request a core interpreter has not occurred, the process returns to 3602 to see if an alternative on-call interpreter may be reached. The process repeats through 3603 to 3608. If in 3608, a trigger event to request a core interpreter has occurred, in 3609, a core interpreter is paged, using any communication method used to request an on-call interpreter. The core interpreter may also be at a terminal within the health information exchange system and have a direct connection to the system while also serving as a system administrator. In 3610, the notification process ends.

FIG. 3h illustrates a flowchart of an example process of the charging calculation for determining the payment to be made by a health information provider for interpretation of a health information, according to the example embodiment of FIG. 3a. In 3700, the charging calculation starts for a health information. In 3701, the minimum fixed price or minimum price paid may be the base price in the total. There may be a separate minimum fixed price for a preliminary interpretation versus a final interpretation. If in 3702, any send parameters were used to filter and obtain an interpreter, for example, a specialist interpreter or that of a minimum quality rating, in 3703, those additional fees are calculated and added to the total. Additional fees may be the rating price, the general price, or a combination thereof, as explained above in FIG. 3e. A fixed fee may be added as a function of the send parameter options, not only if the health information provider chose the send parameter options, but even the number of options that were available to the health information provider. For example, any special send parameters that were added at the request of a health information provider may require altering the matching system, and this would require some sort of labor that would be charged as a fixed fee for those health information that required special send parameters.

If in 3702, no special send parameters were used, then the process proceeds directly to 3704. In 3704, if there was a time lapse such that the health information aged, thereby increasing the price to capture more interpreters, in 3705, the variable increment fee is calculated and added to the total bill. As explained above, some more examples of time varying fees may be receiving an additional fee as a function of a fixed amount of time to provide an interpretation after a health information is received by the health information exchange system or actually input into the health information matching system. The fixed transaction fee may be a function of a time frame for a health information to be interpreted. Another example time varying fee may be an additional fee based on a pre-determined time of day by which an interpretation must be provided, e.g. a deadline or range of deadlines whereby as the deadline becomes later in the day the fee decreases. Another example fee adjustment may be a time frame during which an interpretation must be provided, for example, requiring that an interpretation be provided between noon and 5 pm, or after 11 pm, etc. Another example may be an additional fee for an early expiration time. For instance, a health information exchange system may guarantee that all health information in the system has a turnaround time of 24 hours to provide an interpretation, and if a health information provider requires that the turnaround is shorter, the health information provider may expect to pay a fee per hour before the 24 hour period. Or, the health information exchange system may also adjust this fee from the other direction by having the health information “age” quicker in the system, thereby improving the chance that the health information would be read on an interpreter's worklist.

Another example embodiment may integrate fee parameters, such as calculating a fee as a function of time and the urgency and the type of reading. For example, providers may select a time frame with one of four options: stat, urgent, routine one, and routine two. Stat may be divided into a preliminary interpretation only within 45 minutes and a preliminary interpretation within 45 minutes followed by a final interpretation within 2 hours. Urgent may be a final interpretation within 2 hours. Routine One may be a final interpretation within 6 hours. Routine Two may be a final interpretation within 24 hours.

In 3704, if the health information made it through the system without having to age, the process proceeds directly to 3706. In 3706, all other fees are calculated and added. The other fees may include, for example, the health information exchange system fee. Many of the example methods of calculating fees are explained above in FIG. 3e. For example, a fee may be a fixed portion of a difference, such as a percentage, between a matched send parameter fee and a read parameter fee. A variation may be a fixed portion of a difference between the final send parameter maximum fee and the final bill excluding the fee. An example variation may be setting a fixed transaction fee for interpretation of each health information.

In 3707, a final adjustment to the bill may be to alter the fee based on the market price. For example, the market price may be established by law or regulation, such as the price for reimbursements in accordance with the Medicare or Medicaid physician fee schedule. As another example, the market price may be established by using historical data in the health information exchange system, and determining the average value paid for an interpretation given the characteristics, send parameters, and interpreters online for a given health information. The adjustment process may be to ensure that health information providers are not being overcharged by defects in the system. So long as a profit can be made from interpretation of a health information, the health information provider may even receive a reimbursement. The health information exchange system, may still take a small transaction fee as a function of the reimbursement. In 3708, the charging calculation ends.

FIG. 3i illustrates a flowchart of an example process of attributing ratings based on a reading of a health information, according to the example embodiment of FIG. 3a. The ratings process starts in 3800. In 3801, the health information exchange system may determine if the health information interpretation warrants an adjustment to an interpreter's dependability rating. If not, in 3802, the health information exchange system determines if the health information interpretation warrants a quality rating adjustment. If not, then the ratings adjustment ends in 3813.

In the health information exchange system interpreters may be rated in several categories, as decided by the system administrator. The system may have a quality rating, which measures the skill of the interpreter based on his past interpretations. This may be provided by the health information provider that performs its own quality assurance process or provided by a second interpreter or a health information matching system during a second read. The adjustment of the rating may be as a function of a comparison between a first interpretation and a second interpretation during a second read. The system may also have a dependability rating, which measures an interpreter's use of the system. For example, a dependability rating may be a function of an interpreter's ability to complete interpretations. An interpreter rating may decrease if the interpreter locks up health information without completing the interpretation, thereby requiring a system override and an increase in price or paging of an on-call interpreter to complete the interpretation. The severity of an adjustment to a rating may be determined by the health information matching system, though a system administrator or core interpreter may be able to override the rating adjustment on appeal.

There may be subcategories of the various ratings. For example, an on-call interpreter may have an on-call rating as a sub-rating of the dependability rating. A specialist interpreter may have, for each specialty, a subcategory quality rating for interpretations made for health information that required a specialty interpretation.

Whether an interpretation of a health information warrants an adjustment of the dependability rating or quality rating may depend on various factors. For example, one factor may be that the interpretation of health information is a second read used to determine the quality of a particular interpreter employed by the health information provider. Another example factor may be that an interpreter requests ratings for his interpretations so that he may improve his quality rating to demand a higher price or that he is trying to increase his subspecialty quality rating. The health information exchange system may also require adjustments based on a health information reading if, for example, a health information is interpreted by a relatively new interpreter and the system wanted to create an accurate rating for the interpreter. While an interpreter may request that health information is second read to improve his rating, the health information exchange system may also randomly select health information read by the interpreter to be second read, so that the interpreter does not selectively pick interpretations of health information for which he was more meticulous.

If in 3801 there may be an adjustment to a dependability rating, in 3803, the health information exchange system determines if the interpreter completed a reading. A completed reading may be providing an interpretation to the system. A completed reading may also be indicating that a health information is wrongly categorized and returning the health information to the system requesting the help of a specialist interpreter. Interpreters may not be penalized for not finishing interpretations if there is an error in matching or if an error is caused by the health information provider that incorrectly labels the characteristics of a health information or by requesting unreasonable send parameters. An incomplete reading may be a health information that an interpreter does not get a chance to read or one that a system administrator has to override a lock on the health information because the interpreter is providing an interpretation slower than he estimated he would take. The health information exchange system may not want to encourage rushed or incorrect readings for the sake of efficiency, and these incomplete readings may be appealed by the interpreter. A system administrator or core interpreter may review the appeal.

If a reading is completed, the dependability rating may be improved in 3804, and if not the dependability rating may be lowered in 3805. It may be appreciated that the rating does not have to be a number rating, but may also be any other indicia, such as a grade, a color, etc. The lowering or the improving may reflect the form of indicia.

In 3806, if the interpretation was provided for which an on-call interpreter was requested, a similar adjustment may be provided in 3807. The system administrator may determine that improvements to on-call interpreter ratings may increase at a lower rate because presumably the point of being an on-call interpreter is that they are a back-up system and are paid more to be dependable. Similarly, the system administrator may make penalties for incomplete readings more severe for on-call interpreters. This may be magnified if a core interpreter is requested, but this may be reduced if the on-call interpreter informed the system early that he was unable to make the specific reading while on call. An adjustment of an on-call rating may also be made as a function of the response time of the on-call interpreter, e.g. the time from when the request was made to when the on-call interpreter responded, either by logging onto the system or indicating that he could take the request. Another example adjustment may be based on the total available time the on-call interpreter spends on the system, and the total number of interpretations that the on-call interpreter provides per session, per year, etc.

In 3802, if an adjustment to a quality rating is to be made, as explained above, adjustments may optionally be affected by the health information exchange system in 3808 or the health information provider in 3809. In 3810, if there is a second read performed on the health information, or if the health information is designated for a second read, the quality rating may be held and the rating adjustment pending until the second read rating is received in 3811. Otherwise, in 3812, all the quality ratings are compiled and the quality rating is adjusted accordingly. The health information exchange system may take all the quality ratings and may weight them accordingly. For example, if the health information exchange system rating was determined by a core interpreter, this may be weighted more than that from the health information provider. As another example, a rating from a third interpreter that served as a referee during a second read, may hold more weight than that of a second interpreter. In 3813, the rating adjustment process ends.

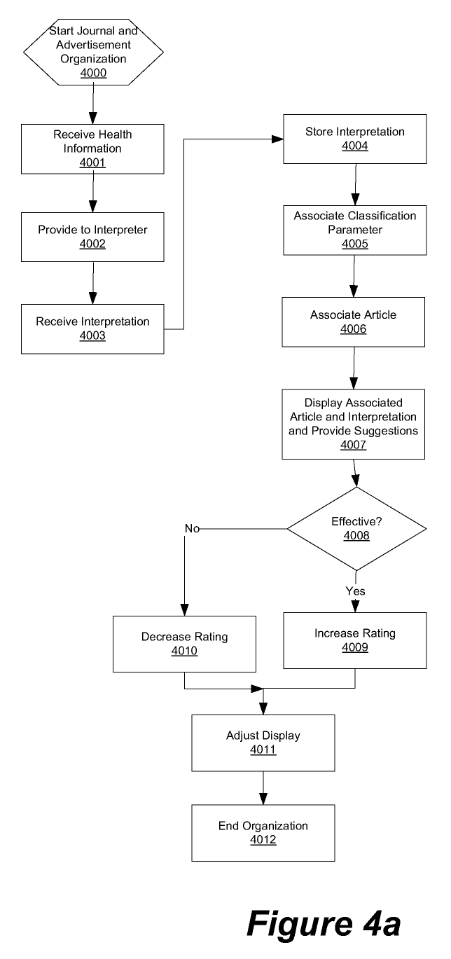

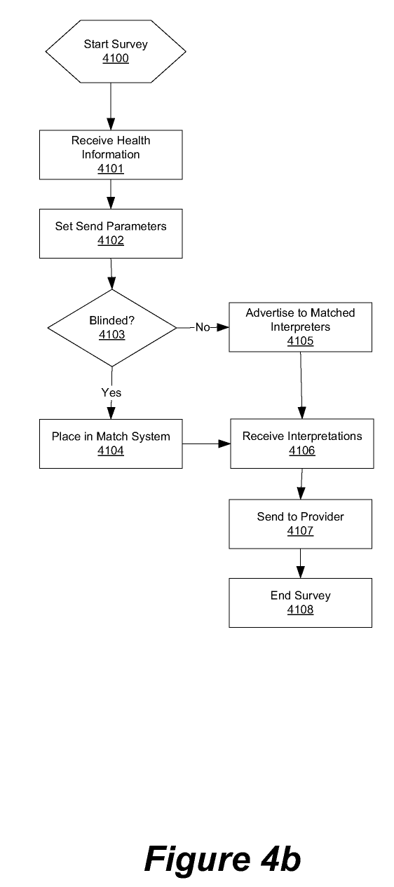

FIGS. 4a and 4b illustrate other example embodiments of processes in a health information exchange system, according to an example embodiment of the present invention.

FIG. 4a illustrates a flowchart of an example process of providing journal articles and advertisements to participants in a health information exchange system, according to an example embodiment of the present invention. In 4000, the process to provide journal articles and advertisements to a participant commences. The information in a health information exchange system may be organized in a manner similar to how health information may be matched to an interpreter or how an interpreter may make an interpretation. For example, health information may be chosen because of the modality or body part. Clinical data may provide symptoms or other prior clinical data, such as blood work, etc. A database may be able to subcategorize the different types of health information and associate the most likely diseases or diagnosis applicable to a specific body part, clinical information, or other data. Journal articles and advertisements may also be subcategorized in a similar fashion. For example, a health information containing data, such as images of an MRI taken in the lumbar region of the spine, may be associated with journal articles discussing lumbar radiculopathy and advertisements for medicine relating to back pain. Interpreters may be provided references and also informed of new drugs or treatments for the particular symptoms, disease, etc. Health information providers, or those reviewing interpretations, may also be presented with advertisements, articles, or example treatment methods. For example, a neurosurgeon reviewing an interpretation of a health information relating to a lumbar spine MRI which demonstrated an abnormality may be presented with therapy options related to that abnormality. Patients may also view advertisements that are related to their health information. Advertisements that may be presented to a certain type of user may not necessarily be the same advertisements presented to a different type of user. For example, as in the example above, the patient of the lumbar spine abnormality may be presented with various advertisements of medications, coupon codes for the medications that the neurosurgeon prescribes, or generic alternatives for the medications.

In 4001, the health information exchange system may receive health information through a communication medium. In 4002, the health information may be provided to an interpreter. This may be through a health information matching system, as described in detail in the example above, or the health information exchange system may designate an interpreter. In other embodiments, a database in the health information exchange system may be built using health information with interpretations already provided. In 4003, if the health information exchange system may receive an interpretation associated with some aspect of the health information.

In 4004, the interpretation may be stored in a storage area, such as a database. The interpretation may be stored and associated with the health information and with any other interpretations already associated with the health information. In 4005, the interpretation may be associated with a classification parameter. Example classification parameters may be a modality, a body part, a disease, a sign, a symptom, a diagnosis, an interpreter, a journal article, etc. The classification parameters for an interpretation may be the same for the health information it is associated with. The classification parameter may also vary. For example, the same health information may have several associated interpretations, and there may be various differences that may cause them to be classified separately, even if they are associated or referenced together in the database.

Health information of similar classification parameters may also be associated together. The interpretations of those health information may then also be associated together. Eventually the database may develop into a network of associations. For example, scans of the back, may be related to symptoms in the leg. Relationships between the various classification parameters and combinations of classification parameters may create a network of relationships.

In 4006, an article or advertisement may be associated with an interpretation or health information as a function of a classification parameter. For example, an article on MRI of the knee may be associated with a modality classification parameter, MRI, or with a trauma classification parameter if, for example, the reason for the performance of the MRI of the knee was a physical injury, or with a sign classification parameter if, for example, the patient who had the MRI of the knee had a joint effusion.

An article or advertisement may even be a link between different health information or interpretations of different classification parameters. For example, a health information may contain images of one modality, such as a CT, and a body part, such as the kidney, and another health information may contain images of a second modality, such as an MRI, and the same body part. An article regarding the effectiveness of CT versus MRI on kidney stones may be an article cross-referencing both types of health information. This may be similarly applied using advertisements for drugs that may be related to several body parts or symptoms.

Advertisements may also be related to articles which are then associated with an interpretation or health information. For example, two advertisements for drugs may be associated with an interpretation providing a diagnosis for an associated health information. An article may be associated with the interpretation, and the article may describe a comparison between the drugs in the advertisements that are associated with the diagnosis of the interpretation.

In 4007, associated articles, advertisements, health information, and interpretations, may be displayed together. The health information exchange system may provide suggestions related to health information. For example, an interpreter may be provided a health information or may pick a health information from a worklist to provide an interpretation. The health information exchange system may display related articles and advertisements for the health information. The health information exchange system may also display related interpretations and health information. For example, a first health information with images of a certain modality, body part, and symptoms may be associated with a second grouping of health information, and the interpretations associated with the second grouping may serve as examples for the interpreter. If the interpreter determines that the diagnosis for the interpretation is not similar to the interpretations of the second grouping of health information, the associations may be re-ordered or removed.

In 4008, as health information, interpretations, etc. are re-ordered or removed in the system, certain health information or interpretations may be rated higher as examples than other health information or related data. The rating may be a teaching rating. The teaching rating may be used as a reference to display or provide the information to an interpreter. For example, if an interpreter suspected that a health information would result in a particular diagnosis, the interpreter may be able to search by the specific diagnosis or disease and receive information, such as articles and health information. Rather than inundating an interpreter with the multitude of examples in the system, the highest rated interpretations and health information may be displayed to the interpreter as best examples. The health information exchange system may alter the examples provided based on the use over time.

In 4008, the interpreter may also determine the effectiveness of the associations or examples. If a data or association was effective, the teaching rating may increase in 4009, or would otherwise decrease in 4010. As the teaching ratings are increased or decreased for various data, in 4011, the display for other interpreters regarding the same information would be altered to reflect the new ratings. In 4012, the organization of associations is completed.

FIG. 4b illustrates a flowchart of an example process of receiving surveys and blind reads from interpreters in a health information exchange system, according to an example embodiment of the present invention. A health information provider may want to accumulate a large amount of blinded reads in order to perform research studies. For example, many legitimate research studies are required to be randomized and double-blind. A health information exchange system may facilitate interpretations that may be blinded and such that the interpretations are randomized. A health information provider may also want to conduct surveys for malpractice suits. For example, a lawyer may want to determine the likelihood that a reasonable interpreter would provide an interpretation similar to that of an interpreter in a lawsuit. Or, a lawyer may want to determine if even a specialist interpreter would provide an interpretation that identified or did not identify a particular diagnosis. The health information exchange system may help in directing the same health information to a randomized group of interpreters and also may provide the information to particular subgroups, such as interpreters with skills and experience similar to the interpreter being sued or with skills that are worse than the skills of the interpreter being sued. The health information exchange system may gather statistics on the interpretations. Statistics may be gathered on the health information and the interpreters that reviewed the health information. For example, the health information exchange system may calculate a standard by determining the percentage of qualified radiologists who visualized a particular finding or compare one acquisition technique of a health information to another to determine in which the abnormality was visible. The interpretations may allow for multi-center, multi-radiologist studies.

In 4100, a survey of the health information may commence. In 4101, the health information exchange system may receive the health information or group of health information provided by a health information provider. In 4102, the health information provider may set its specific send parameters for the survey, possibly aided by the health information exchange system. Send parameters may also relate to an interpreter's qualifications, such as an interpreter's years of training, an interpreter's specialty, the quantity of interpretations an interpreter has reviewed on the health information exchange system or over the course of the interpreter's career, or a rating of the interpreter.

In 4103, if the health information provider is seeking blinded interpreters, the health information may be placed in a health information matching system in 4104. The blinding may be to the various characteristics of the study, or the fact that the health information is part of a survey or study. In 4103, if the health information provider is not seeking blinded interpreters, the health information exchange system may advertise a bonus to matched interpreters. The health information matching system may also allow the health information to appear in more interpreters worklists at a time, but may also balance this so that it does not affect the ability of the health information exchange system to have non-survey health information from being interpreted.

In 4106, the health information exchange system may receive the interpretations from the interpreters and may process the information. Processing may involve creating charts or accumulating the statistical information for the health information provider. In 4107, the entire accumulation of data may be then transmitted to the health information provider. In 4108, the survey process may be complete.

FIGS. 5a to 5f illustrate various example interface screens viewable by a participant, such as a doctor, health information provider, or a third party user, in an example health information exchange system, according to an example embodiment of the present invention.

FIG. 5a illustrates an example health information template interface that may be viewed by a health information provider, according to an example embodiment of the present invention. The interface may display various text boxes, check boxes, or drop down boxes to indicate various options regarding the health information descriptions and send parameters. The health information provider name text box 5000 may automatically be filled in by the health information exchange system. A check box for multiple studies 5001 may indicate if the health information template may be used for only one health information or, if checked, for multiple health information. A drop-down box may indicate if other previously saved templates 5002 may be used. This option may be used in order to re-use the most frequently used settings. In the example, one saved template “Saved 1” may be designated as the default template. There may be an option to use a “New Template,” other named templates such as “Saved 2” and “Saved 3,” or “No template,” indicating the template would be used only once for the particular health information. In addition, a user may browse 5003 for a template, which may be stored in a file.

The template may be for a grouping or multiple studies, and if so, the template may request information regarding the health information or grouping to confirm the accuracy of the data. The template may have a number box 5004 to indicate the number of cases which the template may be applied in the current transaction. A number box for price 5005 may also indicate the maximum price the health information provider may be willing to pay for an interpretation.

The health information date in 5006 and time in 5008 may be input as well as the date out 5007 and time out 5009. The date in 5006 and time in 5008 may be the time the information is placed into the health information matching system. In other example embodiments, the interface may allow a recordation of the date in 5006 and time in 5008 when the health information is actually transmitted to or queried from the health information matching system, or the health information exchange system may automatically timestamp when the health information is actually received. The date out 5007 and time out 5009 may be the threshold times that an interpretation must be received from the health information exchange system. As explained above, in some example embodiments, based on the urgency the maximum time may already be established from the system. The health information exchange system may allow an earlier date out 5007 and time out 5009 if the health information provider is willing to pay more. The health information exchange system may also allow a later date out 5007 and time out 5009 and provide a refund or a lower base cost.

The health information provider template may allow a health information provider to choose states 5010 from which the interpreter may be licensed, and those chosen states may appear in a list of states 5011. A pop-up menu may appear listing all the states and the health information provider may select from the list.

The health information provider may also add interpreters, such as doctors 5012, that are preferred, and remove interpreters, such as doctors 5012, that the health information provider does not want readings from. A pop-up menu may appear that allows a health information provider to select interpreters from a list or to search for interpreters by their identification numbers. If the list is extremely long, health information providers may be able to upload a list that contains all the names or identification numbers of interpreters that are not desired. The list of added or removed doctors may appear in a list 5013. The wanted and unwanted doctors may have different indicia. For example, wanted doctors may appear in green font and unwanted doctors may appear in a red font. As another example, wanted doctors may have a check and unwanted doctors may have an ‘X’ appear next to their name or identification number. Similarly, the health information provider may also add groups 5014 that are wanted or remove groups 5014 that are unwanted and this may also appear in a list 5015.

A health information provider may add bonus options 5016. The health information provider may be provided a pop-up menu with options that allow a health information provider to choose any bonuses that the health information provider may allow. For example, a health information provider may have an extremely long list of unwanted interpreters, eliminating most interpreters in the system, and the health information provider may need to allow a reasonable bonus for the health information matching system to ensure that other interpreters in the system may receive and have incentive to read the health information.

The health information provider may provide a data sheet file 5020 or create a new data sheet file 5019, which may then be in a list of data sheets 5021. A data sheet may be a spreadsheet, text file, template file, image file, etc. that may contain a list of the relevant data regarding a list of health information data. For example, if there are 100 different health information, each with varying characteristics, rather than having to fill in 100 data sheets on an interface one-by-one, the health information provider may upload a data sheet 5020 that already contains all the information. The health information exchange system may then parse or convert the data sheet into its own format to store. The health information exchange system may also provide a template sheet that the health information provider may store and provide data for to upload rather than filling out an interface template. The health information exchange system may also provide an interface template to create a data sheet 5019 on an interface of the system, as will be explained in more detail in FIG. 5b.

The health information provider may also designate a minimum quality rating 5022, a minimum dependability rating 5023, and a minimum specialist rating 5024 in number boxes, similar to 5032. In other embodiments, if the ratings are colors or letters the boxes may reflect those other indicia designating the ratings. If there are multiple specialties desired, as in the list in 5017, the specialist rating may reflect both specialties. The health information provider may request an additional rating later in a special request, as explained below.

The health information provider may view a terms and agreement 5027 and indicate that the terms and agreement have been read and accepted 5026. The health information provider may then provide a template name 5028 in a text box 5029. The template name may be saved and other health information providers or the same health information provider may browse for the template 5003. The health information provider may have the option when saving the template on whether it may be a public or a private template. A public template may be viewable by all other health information providers so that for certain characteristics of health information, all health information providers may want to use the same format of preferences. Private templates may be viewable only by the health information provider, the health information providers network, or those that the health information provider designates as being able to view the template. The health information provider may also designate whether the template may be the default template 5030. The health information provider may then submit the template 5031, and the health information preferences, descriptors, and data may be transmitted to the health information exchange system.

FIG. 5b illustrates an example interface of a data sheet of health information that may be viewed by a health information provider, according to an example embodiment of FIG. 5a. Each data sheet may be for a single health information or for a group of health information. The health information may add data files 5113 gathering all the health information that may be associated with the credentials and preferences of the data sheet. In some example embodiments, the options in FIG. 5b may be placed in the template in FIG. 5a and vice versa. The health information exchange system may place the descriptors and preferences depending on how broadly descriptors and preferences may be applied. For example, the example data sheet provided in FIG. 5a would apply to all of the data files in FIG. 5b, whereas the data files may be varied further by the variables in the figure. If, for example, the modality 5100, was placed in FIG. 5a instead of FIG. 5b, all the data files would have to have the same modality for that template.

In FIG. 5b, the columns indicate descriptors or preferences which apply to all the data in a particular health information data file or health information data file grouping which is added by 5113. The health information data may consist of a modality 5100, for example, a drop-down box 5101 lists an MRI. Another descriptor is the body part 5103, and a drop down box for body parts 5102 shows a chest 5102. Other descriptors may be a clinical data rating 5104 and equipment rating 5105. The clinical data rating, depending on the indicia used for ratings, may provide drop-down number boxes 5116 for the ratings.

The health information provider may also provide indications of whether a specialist 5106 is desired. The drop down box may have the option of saying “No” 5117, or the other options may be minimum rating levels, such as the rating of “2” 5118. Similarly, the health information provider may indicate the minimum number of years of experience 5107 desired, and the options may again be “No” 5120, or “NR” to signify “Not Required,” and may also provide a number similar to other rating number drop down boxes. The health information provider may also indicate whether a second read 5108 is desired for the health information or grouping of health information. The options may be “yes” 5121, or “no” 5109, or possibly even a number rating to indicate the minimum rating of a specialist desired to provide a second read. A number of images 5110 of the files may be indicated. The number 5111, may be provided for the total number in the grouping, or the number of images per health information.

Any special requests 5112, may also be added by configuration indicators 5114. A health information exchange system may consider allowing the health information provider to make special requests or more detailed requests. For example, as explained above a health information provider may have several specialists or subspecialities desired for a health information. The health information may provide a minimum specialist rating and this may apply to both specialties. The health information provider may also request to have different ratings. For example, a health information may need a neurology and pediatric specialist to review, but the minimum rating may be a 7 for neurology and a 3 for pediatrics.

The health information provider may add new rows 5115, or new data or data sets, that may have the same preferences applied for FIG. 5a. A data sheet row may have characteristics and preference applied to all the data files in that row, whether it be a health information or a grouping of health information. When the Finish 5122 button is activated all the files may start transferring and officially enter the system when the final submit button 5031 is entered in FIG. 5a. This would save transmission time while the health information provider is considering its options. In other example embodiments, the finish button 5122 returns the health information provider back to the main health information data template in FIG. 1a.

FIG. 5c illustrates an example interface of a health information template, according to an example embodiment of the present invention. The health information template may be for multiple health information or for a single health information. The example health information template may be used to help the health information provider calculate the costs based on changes to various send parameters. The health information provider may add the data files 5200 to which the health information template preferences and descriptors may apply. The health information provider may input information through available drop-down boxes, such as the one associated with modality 5201. The available categories to add information may be the modality 5202, the body part 5203, and the urgency 5204. The urgency may have options listed, such as the example urgency options in 3705 of FIG. 3h above. The various options may be in a drop down box, such as the one shown with the option “Routine 1 (Final Interpretation within 24 hours)” 5205.

The health information may also provide the date submitted 5206 and time submitted 5207, which may be either the actual time of transmission or the time when the health information may be placed in the health information matching system. Various radio buttons 5208 to 5215 may be used to select options, some with corresponding drop-down menus, such as 5213, or buttons to allow for pop-up menus, such as 5209.

A specialty 5208 may be selected and applied to multiple specialty types 5209. As specialty types are added, additional specialist ratings 5211 may be listed and rated 5213. Other radio buttons may add an On-Call Interpreter option 5210, an Interpreter Rating Requirement option 5212, a Dependability Rating Requirement option 5214, and a Decrease Time of Reading option 5215. In the example interface, the time may be decreased by hourly increments 5218, however, the health information exchange system may adjust the time increments in other embodiments accordingly. Once all the preferences have been made, a health information provider may indicate that it would like an estimated cost 5216, which would be presented in a text box 5217. As the health information provider made further changes to its preferences, the display 5217 may automatically adjust the cost after each change in preference and update the cost range essentially in real-time.

FIG. 5d illustrates an example interface of part of a display for a health information exchange system, according to an example embodiment of the present invention. The example interface may be divided into various screens. A first frame 5300 displays variable information based on menu options 5301 to 5305 that an interpreter may choose. Information that is chosen in the first frame 5300 may be reflected in the other three frames 5319 to 5321.

An interpreter may choose a worklist 5301, which will be explained in more detail below in FIG. 5e. An interpreter may choose an articles list 5302. The articles list may be populated by a search by the interpreter, recommendations by the health information exchange system, or based on updates of an interpreters' subscriptions to journals. The articles list may also contain bookmarked articles. Recommendations may be based on the health information that is currently being viewed. For example, if an interpreter is currently viewing a health information in a second frame 5320, which relates to a chest MRI, the first frame 5300 may automatically update with articles related to chest MRIs. The interpreter may be able to flip back and forth between various menus by selecting the menu options 5301 to 5305. Interpretations may be rewritten or recorded in the third frame 5319. While an interpreter is dictating and typing an interpretation, the health information exchange system may automatically parse the text or data. The health information exchange system may also update an articles list such that when an articles menu option 5302 is selected, the list may reflect the newly added data in the third frame 5319 containing the interpretation.

An interpret menu option 5303 may contain a configuration menu or anything related to the interpretation. For example, it can set the options for typing or dictating. The menu may also contain various codes for the types of diagnosis or information in the system. The interpreter menu 5303 may also bring up all past interpretations that the interpreter has performed. If the interpreter currently has multiple health information locked, the interpreter may toggle between multiple interpretations as well as multiple health information. The interpret menu may also contain form paragraphs for reports and other information.

A history menu 5304 may contain historical information regarding the health information. Historical information may include old clinical data, old images, other newer health information pending in the system that may be related to a patient, etc. An interpreter may view old information in the third window 5320 and as thumbnails, if there are images, in the fourth window 5321. A search menu 5305 may provide searching for all other types of information in the health information exchange system. The searching may include second reads, general health information, medical information, such as drug information, a medical dictionary, etc.

A second frame 5320 may display data that is part of a health information. A fourth frame 5321 may contain thumbnails 5315 or other information of the health information that may be selected to be viewed in the second frame 5320. A selected thumbnail 5312 in the fourth frame 5321 may appear with a larger border, and this may be reflected in its larger associated image 5306 in the second frame 5320. Other thumbnails, such as 5315, may contain thumbnail images, or may contain other types of data, such as clinical information, that may then be displayed in the second frame 5320. Multiple images 5306, 5308, 5322, and 5311 may be displayed that show different slices or the same image but taken with different MRI sequences. For example, if a breast MRI study has T1- and T2-weighted images and post-contrast enhanced images, the same location in the different sequences may be displayed in the multiple frames. Different images may be dragged and dropped into the second window 5320, and the images may automatically be snapped into place. The images can be cascaded or tiled, the number of images in the second frame 5320 may be adjusted, and the images may be resized and manipulated. Clinical data that is displayed may be highlighted and bookmarked.

Images may be panned, zoomed, resized, window/leveled to change contrast and brightness, have various image filters applied, etc. Different regions of an image may need to be focused on. For example, an interpreter may want to focus on a region 5314 in an image 5322. The interpreter may use a pointer 5314, such as a mouse pointer, which may have commands 5323 that may be selected. For example, an interpreter may choose to highlight a region 5314 in one image, select all the other images to highlight the image 5307, 5309, 5310, and then enlarge that region in all the displayed images. The interpreter may then be able to compare specific regions of different images.

The third frame 5319 may contain tools to provide an interpretation. For example, the actual text that is dictated or typed may be displayed in the frame. A toolbar at the bottom of the frame may display various functions. For example, a time remaining 5318 countdown timer may indicate when the interpretation must be made without penalty. If an interpretation is proving too difficult, the interpreter may release 5317 the health information back into the health information matching system. When an interpretation is completed the interpreter may submit 5316 the interpretation for review, second read, or distribution.

FIG. 5e illustrates an example interface of a worklist display, according to an example embodiment of FIG. 5d. The interface may have several tabs 5400 to 5405 displaying various options related to the worklist. Though in the example embodiment information is separated into various tabs, other example embodiments may combine the information together into a window, or allow an interpreter or health information provider to adjust how the information may be separated. A first example tab may be a Final Interpretations tab 5400, which may be all the health information in a worklist that requires a final interpretation. Each row may represent a particular health information, and the various columns indicate characteristics of the health information or preferences of the health information provider. For example, various information column labels may include a modality 5406, a body part 5407, a study description 5408, the number of images in the health information 5409, the time deadline 5410, an equipment rating 5411, a clinical data rating 5411, and a bonus 5412. Other information labels may be added or removed by an interpreter.

The time deadline 5410 may be displayed in several ways. For example, a date and time may be displayed 5427 or a countdown to an expiration time may be displayed 5427. A clinical data rating may be displayed, and a pointer 5426 may be placed over the ratings to display information 5425 relating to the rating, for example, describing the clinical data available. The pointer 5426, may also be placed over other information in the worklist and may display information or manipulate the display. For example, the pointer may have the ability to toggle between the various display formats of the time deadline 5410. A bonus label 5412 may have information displayed in several ways. For example, a bonus information may contain rating numbers 5428, an indication that there is no bonus 5422, or a combination of a number and indicia 5417. The indicia may be a color, for example, as explained above, red for urgent, and green for not urgent, etc. Other information may be displayed, for example, a question mark 5418, may signify that the information has been reviewed once, is a difficult health information to interpret, has been released with a preliminary interpretation or no interpretation at all, and may require that it be re-categorized as requiring a specialist. A lock 5421, may indicate that the health information has just been chosen on another interpreter's worklist and is unavailable to be chosen by selection boxes 5419 and 5420.

Other information may be displayed at the bottom of the frame. For example a tier 5413 may indicate the price tier that the interpreter is at based on the various rating levels. In the example, the interpreter is alerted to the fact that he is in the third tier and does not receive the highest paid interpretations, or that if there are not enough interpretations he may not receive any at all because they may be taken by first or second tier interpreters. An interpreter may then be motivated to take health information to increase the rating. The interpreter rating 5414, on-call rating 5414, and specialty ratings 5415 and 5416 may also be displayed. An interpreter may be a specialist in various areas and may have an independent rating for each specialty area. An interpreter may update 5423 the worklist manually, though the health information exchange system may also update the worklist on a regular basis. The interpreter may select various health information to read and press select 5424 to lock down the studies.

As explained above, the health information may be placed into worklists of various categories. For example, an on-call tab 5401 may contain health information that the on-call interpreter is responding to. If the interpreter is not an on-call interpreter, the tab may allow the interpreter to sign up. A preliminary interpretation tab 5402 may allow interpreters to choose from a worklist of health information that requires a preliminary interpretation. A double readings tab 5403 may allow the interpreter to provide a second read. A credentialing tab 5404 may allow an interpreter to sign up for credentialing so that his interpretations are double read by specialists. The credentialing may also provide options to input licensing numbers or organizations for verification. An adjust parameters tab 5405 allows an interpreter to adjust read parameters in order to adjust the types of health information the interpreter may be willing to receive in hopes of increasing or decreasing the number of health information in the worklist.

Although the example embodiments have been described with reference to radiology, it will be appreciated that example embodiments of the present invention may also be applicable to other medical fields, particularly those involving images, such as dermatology, pathology, ophthalmology, etc.

Several example embodiments of the present invention are specifically illustrated and described herein. However, it will be appreciated that modifications and variations of the present invention are covered by the above teachings and within the purview of the appended claims without departing from the spirit and intended scope of the invention.

What is claimed is:

1. A method for matching, comprising:
receiving one or more health information from a health information provider;
associating a send parameter to the one or more health information, wherein a send parameter is specified by the health information provider;
storing the send parameter and the one or more health information;
receiving a read parameter from a radiologist;
matching one or more health information to the radiologist, wherein the matching is as a function of at least one of the send parameter, read parameter, and a time variable;
providing a first health information to the radiologist; and
receiving an interpretation corresponding to the first health information from the radiologist.

2. A method for matching health information to an interpreter, comprising:
receiving at least a first health information from a health information provider;
associating a send parameter to the first health information;
storing the send parameter and the first health information;
receiving a read parameter from an interpreter;
providing a first health information to a first interpreter; and
receiving an interpretation corresponding to the first health information from the interpreter.

3. The method of matching according to claim 2, further comprising contacting an on-call interpreter.

4. The method of matching according to claim 2, wherein the send parameter is provided by the health information provider.

5. The method of matching according to claim 2, wherein the send parameter is provided by a health care information matching system.

6. The method of matching according to claim 2, further comprising querying the health information provider for additional health information that is associated with the first health information.

7. The method of matching according to claim 2, further comprising querying a second health information provider for additional health information associated with the first health information.

8. The method of matching according to claim 2, wherein the health information is a medical image.

9. The method of matching according to claim 2, wherein the health information is an image data.

10. The method of matching according to claim 2, wherein the health information is historical health information of the patient.

11. The method of matching according to claim 2, wherein the health information is an imaging test.

12. The method of matching according to claim 2, wherein the health information is clinical data.

13. The method of matching according to claim 8, wherein the medical image is a radiology image.

14. The method of matching according to claim 8, wherein the medical image is a pathology image.

15. The method of matching according to claim 2, further comprising: removing personally identifiable information associated with the health information.

16. The method of matching according to claim 2, wherein the interpretation is a preliminary interpretation.

17. The method of matching according to claim 2, wherein the interpretation is a final interpretation.

18. The method of matching according to claim 2, wherein the interpreter is a doctor.

19. The method of matching according to claim 18, wherein the doctor is a radiologist.

20. The method of matching according to claim 2, further comprising: rating the interpreter as a function of the quality of interpretations.

21. The method of matching according to claim 2, further comprising: rating an interpreter as a function of dependability of completing interpretations.

22. The method of matching according to claim 20, wherein the rating is provided by a second interpreter.

23. The method of matching according to claim 20, wherein the rating is provided by a health information matching system.

24. The method of matching according to claim 20, wherein the rating is provided by the health information provider.

25. The method of matching according to claim 2, further comprising: associating a bonus score to an interpreter.

26. The method of matching according to claim 25, wherein the bonus score is a function of at least one of a rating associated with the interpreter; the number of interpretations provided by the interpreter; the number of interpretations received by the interpreter; a comparison of an interpreter's rate of readings compared to other interpreters on a health information matching system; registering as a specialist; availability at designated times of the day; participation in an on-call system; a quality rating of the interpreter.

27. The method of matching according to claim 2, wherein an interpreter is a specialist.

28. The method of matching according to claim 27, further comprising verifying that the fellowship training of a specialist in a subspecialty area.

29. The method of matching according to claim 27, further comprising verifying the academic department in a subspecialty area.

30. The method of matching according to claim 27, further comprising qualifying the interpreter as a specialist after a number of health information interpretations are reviewed by a specialist in a subspecialty area.

31. The method of matching according to claim 2, further comprising:
providing the first health information and associated first interpretation by the first interpreter to a second interpreter;
receiving an opinion of the first interpretation from the second interpreter; and
receiving a second interpretation associated with the first health information.

32. The method of matching according to claim 2, further comprising:
providing health information to a first interpreter;
providing historical health information to the first interpreter; and
receiving an opinion from the first interpreter comparing the health information to historical health information

33. The method of matching according to claim 31, further comprising: comparing the first interpretation to the second interpretation.

34. The method of matching according to claim 2, further comprising:
providing the first health information to a second interpreter; and
receiving an interpretation from the second interpreter.

35. The method of matching according to claim 34, further comprising: comparing the first interpretation to the second interpretation.

36. The method of matching according to claim 34, further comprising: adjusting a rating of the interpreter as a function of at least a comparison of the first plurality of interpretations and second plurality of interpretations.

37. The method of matching according to claim 2, wherein the send parameter is one of a time frame, a range of price, a fixed price, a location of licensure, a minimum price as a function of other send parameters, radiology specialty, a specific group of doctors, a specific doctor, a specific doctor that is not wanted, a doctor whose quality rating is above a threshold, a doctor whose dependability rating is above a threshold, number of doctors actively logged on a health information matching system, the years of experience of a doctor, and number of doctors that are licensed in the location

38. The method of matching according to claim 2, wherein the send parameter is provided in a template, wherein the template is applied to a plurality of health information.

39. The method of matching according to claim 2, wherein the read parameter is at least one of a type of credentialing, type of studies, time of reading, number to read, time period to read a study, or time period per health information interpretation, a fixed price, a fixed minimum read price, a minimum read price as a function of other read parameters, an equipment rating, a clinical data rating and preferred health information providers.

40. The method of matching according to claim 2, wherein the read parameter is provided in a template, wherein the template is applied to a plurality of health information.

41. The method of matching according to claim 39, wherein the credentialing is at least one of a license issued by a State government in one of the 50 States of the United States or one of its Commonwealth, a license issued by a foreign government, an approval by an organizational credentialing body, and a post-graduate training background.

42. The method of matching according to claim 2, wherein the providing of the health information to the interpreter is performed upon the matching of a read parameter and a send parameter.

43. The method of matching according to claim 2, further comprising displaying health information and a parameter, wherein the displayed parameter comprises at least one of a modality, body part, study description, time urgency, total number of images, bonus points, equipment rating, clinical data rating, and an indicia.

44. The method of matching according to claim 2, further comprising displaying health information and an associated parameter, wherein the health information is displayed as a time function, wherein the time function is dependent on time variables comprising one of at least the time the health information was sent by the health information provider, the time the health information was received by the health information exchange system, the time by which an interpretation must be provided.

45. The method of matching according to claim 44, further comprising altering a displayed indicia according to the time function.

46. The method of matching according to claim 44, wherein the time function is pre-determined by the health information provider.

47. The method of matching according to claim 44, wherein the time function is pre-determined by a health information matching system.

48. The method of matching according to claim 44, wherein the time function is variable and depends from a system variable.

49. The method of matching according to claim 48, wherein the system variable is at least one of the time function itself, the number of interpreters currently logged in to the health information matching system, the number of health information awaiting interpretation in the health information matching system, the average amount of time the plurality of health information has been in the health care information matching system, and the number of health care information not provided to any interpreters currently in the health care information matching system.

50. The method of matching according to claim 2, wherein the type of studies would be the modality and the body part.

51. The method of matching according to claim 2, further comprising: notifying at least one of a second plurality of interpreters when a trigger event occurs, wherein the second interpreter is in a subgroup of on-call interpreters.

52. The method of matching according to claim 51, further comprising: adjusting the rating of the plurality of on-call interpreters on dependability of completing readings.

53. The method of matching according to claim 51, wherein a trigger event is at least one of the events comprising a critical time window associated with a health information that still requires interpretation, a minimum number of interpreters in a health information matching system, a minimum number of specialist interpreters in a health information matching system, and a special event trigger.

54. The method of matching according to claim 52, wherein the adjustment of the rating of the on-call interpreter is a function of at least one of the response time of the on-call interpreter, the total available time that the on-call interpreter spends on the system, and the total number of interpretations the on-call interpreter provides.

55. The method of matching according to claim 52, further comprising: removing the on-call interpreter from a list of on-call interpreters when the rating reaches a trigger event.

56. The method of matching according to claim 2, further comprising: providing a bonus as a function of at least one of the time of day availability to be on-call, number of health information read while on-call, number of on-call days taken.

57. The method of matching according to claim 2, further comprising: providing compensation to the plurality of interpreters as a function of at least a rating and a bonus.

58. The method of matching according to claim 51, further comprising notifying at least one of a third plurality of interpreters when a trigger event occurs, wherein the third interpreter comprises a subgroup of core group interpreters.

59. The method of matching according to claim 58, wherein the trigger event is at least one of the events comprising a critical time window associated with a health information that still requires interpretation, a request made by an on-call interpreter, a request made by a health information provider, a request made by one of the interpreters in a health information matching system, a minimum number of interpreters in a health care information matching system, a minimum number of specialist interpreters in a health care information matching system, a minimum number of on-call interpreters available to be notified, and a special event trigger.

60. The method of matching according to claim 21, further comprising: providing the health information to the interpreter in a worklist.

61. The method of matching according to claim 60, further comprising: releasing a lock on the health information in the worklist after a trigger event.

62. The method of matching according to claim 61, wherein the trigger event is the lapse of a pre-determined period of time, wherein the pre-determined period of time is one of the plurality of send parameters.

63. The method of matching according to claim 61, wherein the trigger event is receiving an interpretation of the health information.

64. The method of matching according to claim 61, further comprising adjusting a rating upon the occurrence of the trigger event.

65. The method of matching according to claim 2, wherein providing the health information in a generated worklist, wherein the worklist comprises health information, from the health information matching system, that is matched to the interpreter.

66. The method of matching according to claim 65, wherein the worklist is populated with health information as a function of the matching of the send and read parameters.

67. The method of matching according to claim 65, wherein the interpreters may select a health information from the worklist.

68. The method of matching according to claim 2, further comprising: receiving a fixed portion of a difference between a matched send parameter fee and a read parameter fee.

69. The method of matching according to claim 2, further comprising: receiving a fixed transaction fee.

70. The method of matching according to claim 2, further comprising: receiving an additional fee as a function of at least one of a fixed amount of time to provide an interpretation after a health information is received by the health information exchange system, a pre-determined time of day by which an interpretation must be provided, a frame during which an interpretation must be provided, an early expiration time, a requirement for an interpretation by a specialist interpreter, a requirement for an interpretation based on the quality rating of the interpreter, and to fulfill a send parameter.

71. The method of matching according to claim 2, further comprising: receiving a fixed fee as a function of a time frame for a health information to be interpreted.

72. The method of matching according to claim 2, further comprising: receiving a fixed percentage of the difference between a matched send parameter fee and a read parameter fee.

73. The method of matching according to claim 2, further comprising: receiving a fixed fee as a function of a reimbursement.

74. The method of matching according to claim 2, further comprising: receiving a fixed fee as a function of send parameter options.

75. The method of matching according to claim 2, further comprising: receiving a fee pre-determined as a function of market forces

76. The method of matching according to claim 2, further comprising: refunding part of a fee to a health information provider, wherein the fee is a function of the difference between a maximum and minimum price.

77. The method of matching according to claim 2, further comprising having a health information provider transmit a fee to an interpreter, wherein the fee is related to the health information.

78. The method of matching according to claim 2, further comprising: facilitating a transfer of funds from a health information provider to an interpreter.

79. The method of matching according to claim 2, further comprising: receiving a fee from a payment from a health information provider, and distributing a portion of the fee to an interpreter, wherein the fee is related to the health information.

80. The method of matching health information to an interpreter, comprising:
receiving health information from the health information provider;
storing the health information in storage in a first network;
receiving a registration from an interpreter;
providing the health information to the registered interpreter; and
receiving an interpretation from the interpreter.

81. The method according to claim 80, further comprising receiving a registration from a health information provider.

82. The method according to claim 80, wherein the interpreter is accessing a terminal that is accessible through a second network.

83. The method according to claim 80, wherein the storage is in a health information matching system.

84. The method according to claim 80, wherein the storage is in a third network.

85. The method according to claim 80, further comprising encrypting the health information.

86. The method according to claim 80, further comprising notifying an on-call interpreter if a trigger event occurs.

87. The method according to claim 80, further comprising notifying a core interpreter if a trigger event occurs.

88. A method of providing medical information, comprising:
receiving a plurality of health information from a health information provider;
providing the plurality of health information to a plurality of interpreters;
receiving interpretations from a plurality of interpreters;
storing the interpretations in a storage area; and
associating the interpretations with a classification parameter.

89. The method according to claim 88, wherein the classification parameter is at least one of a modality, a body part, a disease, a sign, a symptom, a diagnosis, an interpreter, a journal article.

90. The method according to claim 88, further comprising: associating a first health information with a second health information based on a classification parameter.

91. The method according to claim 88, further comprising: associating a first health information with a journal article based on a classification parameter.

92. The method according to claim 88, further comprising, assigning a teaching rating to the health information.

93. A method for matching health information to interpreters, comprising:
arranging a plurality of health information in a health information matching system;
filtering by send parameters;
filtering by the interpreter information of interpreters in a health information matching system;
placing a plurality of health information into an interpreter worklist.

94. A method of matching according to claim 93, wherein the health information is sent to an interpreter in the order of the level of urgency.

95. A method of matching according to claim 93, wherein the level of urgency is a function of at least one of the time the health information was placed in a health information matching system, an urgency level indicated by a health information provider, and the amount of time before the health information expires.

96. A method of matching according to claim 93, wherein the send parameters comprise at least one of the licenses required to read the health information, the modality, the body part of the health information, the location of the interpreter, the license of the interpreter, subspecialty of the interpreter, and a requisite qualification of an interpreter.

97. A method of matching according to claim 93, wherein the number of medical information placed into an interpreter worklist is based on a function of at least one of the variables comprising the number of health information in the health information matching system, the number of interpreters in the system, the number of on-call interpreters available, and the number of health information in interpreter worklists.

98. A method of matching according to claim 93, wherein the number of medical information placed into an interpreter worklist is fixed.

99. A method of providing quality assurance, comprising:
receiving a first health information from a health information provider;
providing the first health information to a first interpreter;
receiving a first interpretations associated with the first health information from the first interpreter; and
providing the first health information to a second interpreter.

100. The method according to claim 99, further comprising: wherein the second interpreter is a specialist interpreter.

101. The method according to claim 99, receiving a second interpretation associated with the first health information from the second interpreter.

102. The method according to claim 101, further comprising: comparing the first interpretation with the second interpretation.

103. The method according to claim 99, further comprising: providing the first interpretation to the second interpreter.

104. The method according to claim 103, receiving a rating of the first interpretation from the second interpreter.

105. The method according to claim 102, further comprising: providing the first health information to a third interpreter based on the comparison of the first interpretation and the second interpretation.

106. The method according to claim 99, further comprising: associating a rating to the interpretation as a function of the first interpretation.

107. The method according to claim 106, wherein the rating is given by at least one of the health information provider, a health information exchange system, and the second interpreter.

108. The method according to claim 99, wherein the first plurality of interpretations is a preliminary interpretation, and wherein the preliminary interpretation indicates an emergency action must be taken.

109. A method for providing medical interpretations, comprising:
receiving a first health information;
providing the first health information to a plurality of interpreters, wherein the interpreters are filtered as a function of at least one of the type of health information, subtypes of health information within a given type, interpreter qualifications and interpretation conditions; and
receiving interpretations associated with the first health information from the plurality of interpreters.

110. The method according to claim 109, wherein the interpreter qualification comprise one of at least the interpreter's years of training, the interpreter specialty, the quantity of interpretations the interpreter has reviewed on a health information matching system, and a rating of the interpreter.

111. The method according to claim 109, wherein the interpretation condition is a pre-determined amount of time to interpret the health information.

112. A health information matching system, comprising:
a storage device, wherein a plurality of health information, a plurality of read and send parameters, and a plurality of interpreter profiles are stored;
a processor that matches a plurality of images to a plurality of interpreters to a plurality of health information as a function of read and send parameters;
a server that hosts a plurality of interpreters on the system, and
a remote connection of a first interpreter which connects a terminal of the first interpreter to the host server.

113. The system according to claim 112, further comprising a second remote connection which connects a terminal of a second interpreter to the host server.

114. The system according to claim 112, further comprising a health information provider server, wherein the server can remotely connect and send health information to the host server.

115. The system according to claim 112, further comprising an intermediary server that can receive health information and remove patient identification information from the health information.

116. The system according to claim 115, wherein the removed patient identification information and the health information are associated with a unique identifier.

117. A system for facilitating the matching of medical images to doctors, comprising:
an image server storing images;
a matching server configured to match an image to an interpreter based on a send and read parameter;
a host server connecting to a health information provider and a remote interpreter terminal; and
a data server removing patient identification information from the images and associating a unique identification with the removed data with the image data.

118. A computer readable medium containing instructions that when executed result in a performance of a method comprising:
receiving at least a health information from a health information provider;
matching the first health information to an interpreter as a function of a parameter;
providing a first health information to the interpreter; and
receiving an interpretation corresponding to the health information from the interpreter.
